(19) United States
(12) Patent Application Publication
(10) Pub. No.: US 2005/0181946 A1
(43) Pub. Date: Aug. 18, 2005

(54) Image-recording label sheet and process for image forming

(75) Inventor: Yoshio Tani, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJI PHOTO FILM CO., LTD., Minami-Ashigara-shi (JP)

(21) Appl. No.: 11/047,788

(22) Filed: Feb. 2, 2005

(30) Foreign Application Priority Data
Feb. 12, 2004 (JP) 2004-035364
Aug. 26, 2004 (JP) 2004-247489

(51) Int. Cl. B41M 5/20

(52) U.S. Cl. 503/226

(57) ABSTRACT

The object of the present invention is to provide an image-recording label sheet in which between an image-recording layer and a base, an intermediate layer suppressing the stress is disposed and when the label sheet is adhesive-bonded to a medium having a curved or uneven surface in which an image is transferred from the label sheet, the crazing in the label sheet can be prevented, and which is excellent in adhesion resistance and is preferred for the electrophotography; and a method for forming an image using the image-recording label sheet. For the object, the present invention provides an image-recording label sheet comprising a separator, and at least a peeling treating layer, an adhesive layer, a base, an intermediate layer, and an image-recording layer which are disposed on the separator in this order, wherein every one of the image-recording layer, the intermediate layer and the adhesive layer comprises a thermoplastic resin and the glass transition temperature (Tg1) of the thermoplastic resin in the image-recording layer, the glass transition temperature (Tg 2) of the thermoplastic resin in the intermediate layer and the glass transition temperature (Tg 3) of the thermoplastic resin in the adhesive layer satisfy the inequality: Tg 1>Tg 2>Tg 3.

### BACKGROUND OF THE INVENTION

1. Field of the Invention

The present invention relates to an image-recording label sheet having excellent adhesion resistance in which the image-recording layer can be prevented from the crazing and to a process for image forming using the image-recording label sheet.

2. Description of the Related Art

Conventionally, in a step for fixing a toner in a process for image forming by an electrophotography, for melt-fixing the toner instantaneously according to a received image in a toner image-receiving layer of the image-recording label sheet, as a binder resin in the toner or the toner-receiving layer, usually a thermoplastic resin having sharp melt properties is used. Such a thermoplastic resin has a relative lower molecular weight, so that a disadvantage is caused wherein an image-recording label sheet comprising a toner image-receiving layer produced using such a thermoplastic resin has a small breaking extension and in such an image-recording label sheet, the crazing is easily caused.

In addition, for preventing piled image-recording label sheets for the electrophotograph during the preservation thereof after a image was formed therein, from sticking to each other, it is necessary that the toner and the toner image-receiving layer are produced using a binder resin having a glass transition temperature which is at least a temperature for the preservation of the image-recording label sheet or higher and in this case, a disadvantage is caused wherein in an image-recording label sheet comprising such a binder, the crazing is more easily caused.

On the other hand, it is attempted that in the electrophotography, an image is formed in the image-recording label sheet and the formed image is label-transferred into various media in which an image is transferred. However, in the label-transfer, the label sheet which is adhesive-bonded to a medium in which an image is transferred, is bent and pressed during the adhesive-bonding, so that a toner image-received layer and the toner image-receiving layer are subject to a bending strain and a particular large disadvantage is caused wherein the crazing is caused in the toner image-received layer and the toner image-receiving layer. When a medium (into which an image is transferred) to which the label sheet is adhesive-bonded has a curved or uneven surface, the label sheet itself becomes bent, so that, like in the above-noted label-transfer, the toner image-received layer is subject to the bending strain and the crazing is likely to be caused therein. Further, when a portion of the label sheet used as a label sheet which is adhesive-bonded to another medium, is cut out, a part of the label sheet at which the label sheet is cut out, is subject to a shear strain and a disadvantage is caused wherein the crazing is caused in the toner image-received layer.

Conventionally, with respect to an image-receiving label sheet for an electrophotograph having a high picture quality, for preventing the crazing and the like, various methods are proposed (see Japanese Patent Application Laid-Open (JP-A) Nos. 2000-352834 and 2001-142245).

However, the label sheet comprises the label main form and a separator temporarily adhesive-bonded to the label main form through a tacky layer and has a largely different form, composition or application from that of an image-receiving sheet for the electrophotography. Therefore, it is difficult to apply the technique for the image-receiving sheet for the electrophotography directly to the label sheet and the improvement and development of the technique to apply the technique for the image-receiving sheet for the electrophotography appropriately to the label sheet has been desired nowadays yet.

### SUMMARY OF THE INVENTION

The object of the present invention is to provide an image-recording label sheet in which between an image-recording layer and a base, an intermediate layer suppressing the stress is disposed and when the label sheet is adhesive-bonded to a medium having a curved or uneven surface in which an image is transferred from the label sheet, the crazing in the label sheet can be prevented, and which is excellent in adhesion resistance and is preferred for the electrophotography; and a method for forming an image using the image-recording label sheet.

The image-recording label sheet according to the present invention comprises a separator and at least an adhesive layer, a base, an intermediate layer and an image-recording layer which are disposed on the separator in this order, wherein every one of the image-recording layer, the intermediate layer and the adhesive layer comprises a thermoplastic resin and the glass transition temperature (Tg 1) of the thermoplastic resin in the image-recording layer, the glass transition temperature (Tg 2) of the thermoplastic resin in the intermediate layer and the glass transition temperature (Tg 3) of the thermoplastic resin in the adhesive layer satisfy the inequality: Tg 1>Tg 2>Tg 3. Accordingly, the adhesive layer which is adhesive-bonded directly to a medium to which the image-recording label is adhesive-bonded has a low glass transition temperature and possesses high breaking extension and high flexibility, so that the image-recording label can follow up a fine unevenness of the surface of the medium to which the image-recording label is adhesive-bonded. The intermediate layer is not necessary to follow up a fine unevenness or a crook of the surface of the medium to which the image-recording label is adhesive-bonded; however the intermediate layer can mitigate against deforming stress due to a relative large bending (during the adhesive-bonding of the label) or crook (after the adhesive-bonding of the label) of the label, so that the crazing of the image-recording layer disposed on the intermediate layer can be prevented. When the intermediate layer is too soft, adhesion resistance between the label sheets is impaired; therefore, the intermediate layer is necessary to possess relative high breaking extension. The image-recording layer has a high glass transition temperature, so that in the image-recording layer, the image can be preferably formed and when a label sheet is directly contacted with another label sheet during the preservation of the label sheets piled up, the label sheets can be prevented from the sticking to each other.

Therefore, according to the image-recording label sheet of the present invention, the crazing of the image-recording layer which is likely to be caused, when the label is adhesive-bonded to a medium (into which an image is transferred) which has a curved or uneven surface can be prevented and the label sheet is excellent in adhesion resistance; in addition, in the label sheet, an image of a high picture quality can be recorded.

The method for forming an image according to the present invention comprises a step for forming a toner image in which a toner image is formed in the surface of a toner image-receiving layer of the image-recording label sheet according to the present invention; and a step for fixing the image by smoothing the surface of the image in which the surface of the toner image formed in the above-noted step for forming the toner image is smoothed. In the method for forming the image according to the present invention, an image having a similarly high picture quality to that of a photograph print using a silver salt can be efficiently obtained by a simple treatment.

### BRIEF DESCRIPTION OF THE DRAWINGS

FIG. 1 is a schematic cross-sectional view showing an example of an image-recording label sheet according to the present invention.

FIG. 2 is a schematic view showing an example of an image-fixing machine by smoothing the surface of the image according to the present invention.

FIG. 3 is a schematic view showing an example of an apparatus for forming the image according to the present invention.

FIG. 4 is a schematic view showing an example of an image-fixing machine by smoothing the surface of the image as a part of an apparatus for forming the image according to the present invention.

### DESCRIPTION OF THE PREFERRED EMBODIMENTS

(Image-Recording Label Sheet)

The image-recording label sheet according to the present invention comprises a separator and at least a peeling treating layer, an adhesive layer, a base, an intermediate layer and an image-recording layer which are disposed on the separator in this order, and optionally other layers, such as a reflective layer, a tint controlling layer, a shelf stability improving layer, an anti-adhesion layer, an anti-curling layer and a smoothing layer. These layers may be in a single-layer structure or a laminated structure.

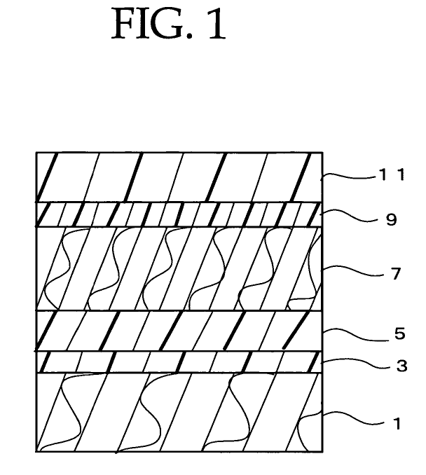

Specific examples of the image-recording label sheet include a label sheet comprising, as shown in FIG. 1, a separator 1 and a peeling treating layer 3, an adhesive layer 5, a base 7, an intermediate layer 9, and an image-recording layer 11 which are disposed on the separator 1.

The image-recording layer 11 is preferably a layer comprising an image-receiving layer and a colorant. When the image-receiving layer is a toner image-receiving layer, the colorant is a toner. When the image-receiving layer is an image-receiving layer for an ink jet recording, the colorant is ink. When the image-receiving layer is an image-receiving layer for a thermofusible transfer, a sublimation dye transfer or a thermosensitive recording, the colorant is a material for the transfer.

The image-recording label sheet according to the present invention is preferably an image-recording label sheet having a guide line for cutting the sheet prepared by a perforation method. “guide line for cutting the sheet” means a line along which the sheet can be cut into labels in a desired size and form.

The guide line may be prepared by a conventional perforation method, either on a surface or reverse surface of the sheet or through the sheet. The guide line may be prepared either before or after the image-recording; however from the viewpoint of suppressing the density and length of the crazing caused by cutting the sheet, the guide line is prepared preferably after the image-recording.

In the present invention, by adopting the below-mentioned composition of the image-recording label sheet, when a part of the sheet is cut along the guide line as an image-recording label, even if a cut edge is subject to shear stress, the crazing is not caused in the toner image-received layer.

In the present invention, every one of the image-recording layer, the intermediate layer and the adhesive layer comprises a thermoplastic resin. The glass transition temperature (Tg 1) of the thermoplastic resin in the image-recording layer, the glass transition temperature (Tg 2) of the thermoplastic resin in the intermediate layer and the glass transition temperature (Tg 3) of the thermoplastic resin in the adhesive layer satisfy the inequality: Tg 1>Tg 2>Tg 3. The glass transition temperature (Tg 1) of the thermoplastic resin in the image-recording layer is preferably from 40 to 100° C., more preferably from 50 to 100° C. The glass transition temperature (Tg2) of the thermoplastic resin in the intermediate layer is preferably from −50 to 50° C., more preferably from −25 to 40° C. The glass transition temperature (Tg 3) of the thermoplastic resin in the adhesive layer is preferably 0° C. or lower, more preferably −10° C. or lower.

The breaking extension (S 1) of the thermoplastic resin in the image-recording layer, the breaking extension (S 2) of the thermoplastic resin in the intermediate layer and the breaking extension (S 3) of the thermoplastic resin in the adhesive layer satisfy preferably the inequality: S 1<S 2<S 3. The breaking extension (S 2) of the thermoplastic resin in the intermediate layer is preferably 20% or more.

The reason why it is necessary that the glass transition temperatures Tg 1, Tg 2 and Tg 3 and the breaking extensions S 1, S 2 and S 3 satisfy respectively the above-noted inequlities: Tg 1>Tg 2>Tg 3 and S 1>S 2>S 3 in the present invention, is as follows.

The adhesive layer which is adhesive-bonded directly to a medium to which the image-recording label is adhesive-bonded, is necessary to be able to follow up a finely uneven surface of a medium to which the image-recording label is adhesive-bonded; therefore, the adhesive layer needs largest flexibility among the above-noted three layers and it is necessary that the adhesive layer has a low glass transition temperature and a high breaking extension. The intermediate layer is not necessary to follow up a finely uneven surface of the medium to which the image-recording label is adhesive-bonded; however, the intermediate layer is necessary to be able to mitigate against deforming stress due to a relative large bending (during the adhesive-bonding of the label) or crook (after the adhesive-bonding of the label) of the label, so that the crazing of the image-recording layer disposed on the intermediate layer can be prevented.

When the intermediate layer is too soft, adhesion resistance between the label sheets is impaired; therefore, the intermediate layer is necessary to possess relative high breaking extension. Since the image-recording layer in which an image is formed is contacted directly with another label sheet during the preservation of the label sheets piled up, the image-recording layer is necessary to have a high glass transition temperature.

A thermoplastic resin in the image-recording layer means a mixture of a thermoplastic resin in the image-receiving layer and a thermoplastic resin as a colorant and when the image-receiving layer is the toner image-receiving layer, the glass transition temperature of the thermoplastic resin in the image-recording layer means the glass transition temperature of a mixture of a binder resin in the toner image-receiving layer and a binder resin in the toner. More specifically, when the above-noted two binder resins are completely compatibilized, the glass transition temperature of the thermoplastic resin in the image-recording layer indicates a single glass transition temperature. On the other hand, when the above-noted two binder resins are not compatibilized, the glass transition temperature of the thermoplastic resin in the image-recording layer indicates and means the both of two respective glass transition temperatures of the above-noted two binder resins.

A sample of the intermediate layer for measuring the breaking extension of the intermediate layer was prepared as follows. A composition for an intermediate layer was coated on a hydrophobic base, such as a polyethylene by means of a wire bar so that an intermediate layer has a thickness of from 10 to 40 μm and the resultant coating was dried, thereby obtaining an intermediate layer. A sample of an intermediate layer was cut out of the obtained intermediate layer in the form of a strip having a size of 5 mm ×70 mm and with respect to the obtained sample, the breaking extension of the intermediate layer was measured using a tensile tester (manufactured and sold by Orientech Co., Ltd.: trade name; Tensilon RTM-50) under the condition where the tensile strength is 500 mm/min. The breaking extension can be measured in terms of elongation (%) which is the ratio of an extension length of the breaking point in the sample to the original length of the sample.

—Separator—

The separator is not restricted and may be properly selected depending on the application. Examples of the separator include examples of the base mentioned below. Among them, a paper in high quality, a paper in middle quality and a resin film are preferably used. Examples of the resin film include a polyethyleneterephthalate film, a polyethylenenaphthalate film, a polycarbonate film, a polypropylene film, a polyimide film, a polystyrene film, an oriented polyethylene film, an oriented polypropylene film, a polyester film, an oriented polyester film and a nylon film. The resin film may comprise various additives.

The thickness of the separator is not restricted, may be properly selected depending on the application and is preferably from 5 to 200 μm.

—Peeling Treating Layer—

The peeling treating layer comprises at least a peeling agent and optionally other components.

The peeling agent is not restricted and may be selected properly depending on the application. Examples of the peeling agent include silicone resins of an emulsion type, a solvent type and a non-solvent type, a fluorine resin, an aminoalkyd resin and a polyester resin. These resins may be used individually or in combination. Among them, from the viewpoint of peel strength, safety, low pollutive properties and cost, an addition-reactive silicone of a none-solvent type is preferably used.

The other components are not restricted and may be selected properly depending on the application. Examples of the other components include a curing catalyst and various additives.

The peeling treating layer is disposed on the separator by coating the separator with a coating liquid for the peeling treating layer.

The amount of the coating liquid for the peeling treating layer applied to the surface of the separator (in a mass of the solid) is preferably from 0.4 to 3.0 g/m², more preferably from 0.5 to 2.0 g/m². When the amount of the coating liquid is less than 0.4 g/m², satisfactory peel property of the peeling treating layer cannot be obtained. On the other hand, when the amount of the coating liquid is more than 3.0 g/m², peel property of the peeling treating layer becomes to large and a disadvantage is likely to be caused wherein the label is peeled from the label sheet during the conveyance of the label sheet in the printer.

—Adhesive Layer—

The adhesive layer comprises at least a thermoplastic resin as an adhesive and optionally other components.

The adhesive is not restricted so long as the adhesive is an adhesive thermoplastic resin and may be selected properly from conventional adhesives depending on the application. Examples of the adhesive include adhesives of an acryl type, a styrene type, a vinyl chloride type, a vinyl acetate type, a polyester type, a polyurethane type, a polyolefin type, an epoxy type and a silicone type.

The glass transition temperature of a thermoplastic resin in the adhesive layer is, as mentioned above, preferably 0° C. or lower, more preferably −10° C. or lower.

The breaking extension of a thermoplastic resin in the adhesive layer is, as mentioned above, larger than those of thermoplastic resins in the image-recording layer and the intermediate layer and usually preferably 50% and more.

The adhesive layer has a thickness of preferably from 5 to 30 μm, more preferably from 10 to 20 μm.

—Base—

The base is not restricted and may be properly selected depending on the application. Preferred examples of the base include a raw paper, a synthetic paper, a synthetic resin sheet, a coated paper and a laminated paper. These bases may be used individually or in combination as a laminated form of plural types.

—Raw Paper—

The raw paper is not restricted and may be properly selected depending on the application. Preferred specific examples of the raw paper include a woodfree paper, such as a paper described in the literature “Basis of Photographic Technology-silver halide photograph (edited by The Society of Photographic Science and Technology of Japan and published by Corona Publishing Co., Ltd. (pp.223-240 (1979))”

The raw paper is not restricted so long as the raw paper is a conventional material used for the base and may be properly selected from various types of materials depending on the application. Examples of the materials of the raw paper include a natural pulp made from a needle-leaf tree or a broadleaf tree and a mixture of the natural pulp and the synthetic pulp.

As a pulp which can be used as a material for the raw paper, from the viewpoint of improving simultaneously surface smoothness, stiffness and dimensional stability (curling properties) of the raw paper in a good balance and to a satisfactory level, broadleaf tree bleached craft pulp (LBKP) is preferred. Needle-leaf bleached craft pulp (NBKP) and broadleaf tree sulfite pulp (LBSP) can also be used.

For beating the pulp, a beater or a refiner can be used.

For suppressing the shrinkage of the paper in the step for making the paper, the Canadian Standard Freeness (CSF) of the pulp is preferably from 200 to 440 ml CSF, more preferably from 250 to 380 ml CSF.

The pulp slurry (hereafter, occasionally referred to as “pulp paper material”) which is obtained after beating the pulp comprises optionally various additives, such as a filler, a dry paper reinforcer, a sizing agent, a wet paper reinforcer, an adhesion promoter, a pH controller and other agents.

Examples of the filler include calcium carbonate, clay, kaolin, white clay, talc, titanium oxide, diatomaceous earth, barium sulfate, aluminum hydroxide and magnesium hydroxide.

Examples of the dry paper reinforcer include cationic starch, cationic polyacrylamide, anionic polyacrylamide, amphoteric polyacrylamide, carboxy-modified polyvinyl alcohol.

Examples of the sizing agent include a compound containing a higher fatty acid, such as a rosin derivative, such as a salt of a higher fatty acid, rosin, maleic rosin; paraffin wax; an alkyl ketene dimmer; alkenyl succinic anhydride (ASA) and an epoxidized fatty amide. Among them, an alkyl ketene dimmer and epoxy aliphatic amide are particularly preferred.

Examples of the wet paper reinforcer include a polyamine polyamide epichlorohydrin, a melamine resin, a urea resin and an epoxidized polyamide resin.

Examples of the adhesion promoter include a multivalent metal salt, such as aluminum sulfate and aluminum chloride; and a cationic polymer, such as a cationic starch.

Examples of the pH controller include caustic soda and sodium carbonate.

Examples of the other agents include an anti-foaming agent, a dye, a slime control agent and a fluorescent whitening agent.

Further optionally, the pulp slurry may comprise a flexibilizer. Examples of the flexibilizer include an agent described in the literature “Paper and Paper Treatment Manual (published by Shiyaku Time Co., Ltd. (pp. 554-555 (1980)).

These various additives may be used individually or in combination. The amount of the various additives in the pulp paper material is not restricted and may be selected depending on the application. The amount is preferably from 0.1 to 1.0% by mass, based on the mass of the pulp paper material.

The pulp paper material (which is optionally prepared by incorporating the various additives into the pulp slurry) is subject to the papermaking using a paper machine, such as a manual paper machine, a Fourdrinier (long-net) paper machine, a round-net paper machine, a twin-wire machine and a combination machine, and the made paper is dried to produce the raw paper. If desired, either before or after the drying of the made paper, the made paper may be subject to the surface sizing treatment.

The treating liquid used for the surface sizing treatment is not restricted and may be properly selected depending on the application. Examples of the compound contained in the treating liquid include a water-soluble polymer, a waterproof compound, a pigment, a dye and a fluorescent whitening agent.

Examples of the water-soluble polymer include a cationic starch, a polyvinyl alcohol, a carboxy-modified polyvinyl alcohol, a carboxymethylcellulose, a hydroxyethylcellulose, a cellulose sulfate, gelatin, casein, a sodium polyacrylate, a sodium salt of styrene-maleic anhydride copolymer and a sodium salt of polystyrenesulfonic acid.

Examples of the waterproof compound include latex emulsions, such as a styrene-butadiene copolymer, an ethylene-vinyl acetate copolymer, a polyethylene and a vinylidene chloride copolymer; and a polyamide polyamine epichlorohydrin.

Examples of the pigment include calcium carbonate, clay, kaolin, talc, barium sulfate, titanium oxide.

From the viewpoint of improving stiffness and dimensional stability (curling properties) of the raw paper, it is preferred that with respect to the raw paper, the ratio (Ea/Eb) of the longitudinal Young's modulus (Ea) and the lateral Young's modulus (Eb) is in the range of from 1.5 to 2.0. When the ratio (Ea/Eb) is less than 1.5 or more than 2.0, the stiffness and the curling properties of the image-recording material may be easily impaired, so that a disadvantage is caused wherein the conveyability of the image-recording material is hindered.

Generally, it is clarified that the “nerve” of the paper is varied depending on the method for beating the pulp and as an important index indicating the “nerve” of the paper, the modulus of elasticity of the paper made by the papermaking after the beating of the pulp, can be used. The modulus of elasticity of the paper can be calculated according to the following equation:
E=pc²(1−n²)
where “E” represents dynamic modulus, “p” represents the density of the paper, “c” represents the velocity of sound in the paper, and “n” represents the Poisson's ratio,
   by using the relation between the dynamic modulus of the paper indicating the properties as a viscoelastic body and the density of the paper, and the velocity of sound in the paper measured using an ultrasonic oscillator.

In addition, since n =0.2 or so with respect to an ordinary paper, there is not much difference between the calculation of the dynamic modulus according to the above-noted equation and the calculation according to the following equation:
E=pc².

Accordingly, when the density of the paper and the velocity of sound in the paper can be measured, the elastic modulus of the paper can easily be calculated. For measuring the velocity of sound in the paper, various conventional instruments, such as a Sonic Tester SST-110 (Manufactured and sold by Nomura Shoji Co., Ltd.) can be used.

For imparting a desired mean center line roughness to the surface of the raw paper, it is preferred that the raw paper is produced, as described in JP-A No. 58-68037, using a pulp fiber having a fiber length distribution in which a total of a 24 mesh screen remnant and a 42 mesh screen remnant is from 20 to 45% by mass and a 24 mesh screen remnant is 0.5% by mass or less, based on the mass of all pulp fibers. Moreover, the mean center line roughness of the raw paper can be controlled by subjecting the raw paper to a surface treatment of applying the heat and pressure by means of a machine calendar or a super calendar.

The thickness of the raw paper is not restricted and may be properly selected depending on the application. The thickness is usually preferably from 30 to 500 μm, more preferably from 50 to 300 μm, still more preferably from 100 to 250 μm. The basis weight of the raw paper is not restricted and may be properly selected depending on the application. The basis weight is preferably from 50 to 250 g/m², more preferably from 100 to 200 g/m².

—Synthetic Paper—

The synthetic paper is a paper comprising mainly another polymer fiber than a cellulose and examples of the above-noted another polymer fiber include a polyolefin fiber, such as a polyethylene fiber and a polypropylene fiber.

—Synthetic Resin Sheet (Film)—

Examples of the synthetic resin sheet include a synthetic resin shaped into the form of sheet, such as a polypropylene film, an oriented polyethylene film, an oriented polypropylene film, a polyester film, an oriented polyester film and a nylon film. In addition, a film whitened by orienting the film and a white film comprising a white pigment can be also used.

—Coated Paper—

The coated paper is a paper produced by coating either a single surface or both surfaces of the base, such as the raw paper with various resins and the amount of a resin as a coating material is varied depending on the application of the coated paper. Examples of the coated paper include an art paper, a cast-coated paper and a Yankee paper.

The resin with which the surface of the raw paper is coated is not restricted and may be properly selected depending on the application. The resin is preferably a thermoplastic resin. Examples of the thermoplastic resin include (1) polyolefin resins and derivatives thereof, (2) polystyrene resins, (3) acrylic resins, (4) a polyvinyl acetate and derivatives thereof, (5) polyamide resins, (6) a polyester resin, (7) a polycarbonate resin, (8) a polyether resin (or an acetal resin), and (9) other resins. These thermoplastic resins may be used individually or in combination.

Examples of the polyolefin resins (1) include polyolefin resins, such as a polyethylene and a polypropylene; and a copolymer resin produced by copolymerizing an olefin, such as ethylene and propylene with another vinyl monomer. Examples of such a copolymer resin (produced by copolymerizing an olefin with another vinyl monomer) include an ethylene-vinyl acetate copolymer and an ionomer resin which is produced by copolymerizing an olefin with acrylic acid or methacrylic acid. Examples of the derivatives of the polyolefin resins include a chlorinated polyethylene and a chlorosulfonated polyethylene.

Examples of the polystyrene resins (2) include a polystyrene resin, a styrene-isobutylene copolymer, an acrylonitrile-styrene copolymer (AS resin), an acrylonitrile-butadiene-styrene copolymer (ABS resin) and a polystyrene-maleic anhydride resin.

Examples of the acrylic resins (3) include a polyacrylic acid and esters thereof, a polymethacrylic acid and esters thereof, a polyacrylonitrile and a polyacrylamide. The properties of an ester of the poly(meth)acrylic acid are largely varied depending on the type of an ester group contained in the ester of the poly(meth)acrylic acid. Also, examples of the acrylic resins (3) include a copolymer produced by copolymerizing, for example, acrylic (methacrylic) acid with another monomer (e.g., methacrylic (acrylic) acid, a styrene and a vinyl acetate). The polyacrylonitrile is used more frequently as a material of the As resin or the ABS resin than as a homopolymer (i.e., as it is).

Examples of a polyvinyl acetate and derivatives thereof (4) include a polyvinyl acetate, a polyvinyl alcohol produced by saponifying the polyvinyl acetate and a polyvinylacetal resin produced by reacting the polyvinyl alcohol with an aldehyde (e.g., formaldehyde, acetaldehyde and butyraldehyde).

The polyamide resins (5) are polycondensates of a diamine and a dibasic acid and examples thereof include 6-nylon and 6,6-nylon.

The polyester resin (6) is a polycondensate of an acid and an alcohol and the properties of the polyester resin are largely varied depending on the type of the combination of an acid and an alcohol. Specific examples of the polyester resin (6) include a versatile resin produced from an aromatic dibasic acid and a bifunctional alcohol, such as a polyethyleneterephthalate and a polybutylenephthalate.

General examples of the polycarbonate resin (7) include a polycarbonate ester produced from bisphenol A and phosgene.

Examples of the polyether resin (or an acetal resin) (8) include a polyether resin, such as a polyethylene oxide and a polypropylene oxide (or an acetal resin produced by a ring opening polymerization, such as a polyoxymethylene).

The other resins (9) include a polyurethane resin produced by an addition polymerization.

The thermoplastic resin may optionally comprise a brightener, a conductive filler, a filler, titanium oxide, and a pigment or dye, such as a ultramarine and a carbon black.

—Laminated Paper—

The laminated paper is a paper produced by laminating a material for the laminating, such as various resins, a rubber, a polymer sheet or a polymer film on the surface of the base, such as the raw paper. Examples of the material for the laminating include a polyolefin resin, a polyvinyl chloride resin, a polyester resin, a polystyrene resin, a polymethacrylate resin, a polycarbonate resin, a polyamide resin and a triacetyl cellulose. These resins may be used individually or in combination.

The polyolefin is, in general, frequently formed using a low-density polyethylene. For improving heat resistance of the base, however, it is preferred to use a polypropylene resin, a mixture of a polypropylene resin and a polyethylene resin, a high-density polyethylene resin or a mixture of a high-density polyethylene resin and a low-density polyethylene resin. Particularly from the viewpoint of cost and laminatability, it is most preferred to use the mixture of a high-density polyethylene resin and a low-density polyethylene resin.

It is preferred that the high-density polyethylene and the low-density polyethylene have a blending ratio (mass ratio) of from 1/9 to 9/1, more preferably from 2/8 to 8/2, still more preferably from 3/7 to 7/3.

For forming the thermoplastic resin layer on both surfaces of the raw paper, it is preferred that the rear surface of the raw paper is produced using a high-density polyethylene resin or a mixture of a high-density polyethylene resin and a low-density polyethylene resin. The molecular weight of the polyethylene resin is not restricted and may be properly selected depending on the application; however, preferred is a polyethylene resin in which the melt index of both the high-density polyethylene resin and the low-density polyethylene resin is from 1.0 g/10 min to 40 g/10 min and which has extrudability.

The sheet or film of the above-noted preferred polyolefin resin may be subject to a treatment of imparting white reflectivity. Examples of such a treatment include a method for incorporating a pigment, such as titanium oxide in the composition of the sheet or film.

The base has a thickness of preferably from 25 to 300 μm, more preferably from 50 to 260 μm, still more preferably from 75 to 220 μm.

<Intermediate Layer>

The intermediate layer comprises at least a thermoplastic resin and optionally other components. As the thermoplastic resin, at least one of a water-soluble resin and a water-dispersible resin which have a glass transition temperature (Tg) of from −50 to 50° C. is preferred. Among these resins, a water-dispersible polyester resin and a water-dispersible acryl resin are preferred.

The water-dispersible resins are preferred in that the resins contain no solvent and not only during the production of the image-recording layer, but also after the adhesive-bonding of the recording label, no volatilization of a residual solvent is caused, so that the resins have high safety for the environment and humane. Since the water-dispersible polyester resin and the water-dispersible acryl resin have a large cohesive energy and are excellent in toner fixation properties (of the toner image-receiving layer) and breaking resistance (of the intermediate layer), the resins are particularly preferred as a material for producing a recording label sheet for the electrophotography.

The water-dispersible polyester resin is not restricted and may be properly selected from conventional resins which are properly synthesized or commercially available. Examples of the water-dispersible polyester resin which is commercially available include Elitel series (manufactured and sold by Unitika Ltd), UE series (manufactured and sold by Kao Corporation), Finetex series (manufactured and sold by Dainippon Ink & Chemicals Inc.), Polyester series (manufactured and sold by Nippon Synthetic Chemical Industry Co., Ltd.), Vylonal series (manufactured and sold by Toyobo Co., Ltd.), Pluscoat series (manufactured and sold by Goo Chemical Co., Ltd.) and Pesresin series (manufactured and sold by Takamatsu Oil & Fat Co., Ltd.).

The water-dispersible acrylic resin is not restricted and may be properly selected from conventional resins which are properly synthesized or commercially available. Examples of the water-dispersible polyester resin which is commercially available include Hiros XE and PE series (manufactured and sold by Seiko Chemical Industries Co., Ltd.), Bon coat series (manufactured and sold by Dainippon Ink & Chemicals Inc.) and Johncryl series (manufactured and sold by Johnson Polymer Inc.).

The intermediate layer comprises preferably further a polyethylene oxide from the viewpoint of plasticizing the undercoating layer. The polyethylene oxide having an average molecular weight of 100,000 or more is preferred.

When the polyethylene oxide is incorporated in a resin composition of the intermediate layer, the mixing ratio in the mass (A:B) of the water-soluble or water-dispersible polymer (A) and the polyethylene oxide (B) is preferably from 1:0 to 1:10, more preferably from 1:0.15 to 1:1.

The breaking extension of the intermediate layer is, as noted above, preferably 20% or more, more preferably 30% or more, still more preferably 40% or more. The breaking extension has particularly no upper limit; however it is generally 500% or less.

When the breaking extension of the intermediate layer is less than 20%, a disadvantage is caused wherein the crazing is caused in the image-recording layer, when the recording label is adhesive-bonded to a medium having a curved or uneven surface in which the image is transferred, so that the glossiness of the recording label is likely to be impaired.

A sample of the intermediate layer for measuring the breaking extension of the intermediate layer is prepared as follows. A composition for an intermediate layer is coated on a hydrophobic base by means of a wire bar so that an intermediate layer has a thickness of from 10 to 40 μm and the resultant coating was dried, thereby obtaining an intermediate layer. A sample of an intermediate layer is cut out of the obtained intermediate layer in the form of a strip having a size of 5 mm ×70 mm and with respect to the obtained sample, the breaking extension of the intermediate layer is measured by means of a tensile tester (manufactured and sold by Orientech Co., Ltd.: trade name; Tensilon RTM-50) under the condition where the tensile strength is 500 mm/min. The breaking extension is measured in terms of elongation (%) which is the ratio of an extension length of the breaking point in the sample to the original length of the sample.

The thickness of the intermediate layer is preferably from 1 to 10 μm, most preferably less than that of the image-recording layer. When the thickness of the intermediate layer is less than 1 μm, the crazing preventing effect of the intermediate layer may be largely lowered. On the other hand, when the thickness is more than 10 μm, the adhesion resistance of the image-recording label sheet may be lowered.

<Image-Recording Layer>

The image-recording layer means, as noted above, a layer comprising an image-receiving layer and a colorant. Examples of the image-receiving layer include a toner image-receiving layer, an image-receiving layer for a thermofusible transfer, an image-receiving layer for a sublimation dye transfer, an image-receiving layer for a thermosensitive recording and an image-receiving layer for an ink jet recording.

The colorant can be properly selected depending on the type of the image-receiving layer and is, for example, a toner for the toner image-receiving layer, ink for the image-receiving layer for an ink jet recording or a material for the transfer for the image-receiving layer for a thermofusible transfer, a sublimation dye transfer or a thermosensitive recording.

Among them, the combination of the toner image-receiving layer and the toner is preferred.

The image-receiving layer in the image-recording layer comprises at least a thermoplastic resin and optionally other components. As the thermoplastic resin, at least one of a water-soluble resin and a water-dispersible resin which have a glass transition temperature (Tg) of from 40 to 100° C. is preferred. Among these resins, a water-dispersible polyester resin and a water-dispersible acryl resin are preferred.

The water-dispersible polyester resin is not restricted and may be properly selected from conventional resins which are properly synthesized or commercially available. Examples of the water-dispersible polyester resin which is commercially available include Elitel series (manufactured and sold by Unitika Ltd.), UE series (manufactured and sold by Kao Corporation), Finetex series (manufactured and sold by Dainippon Ink & Chemicals Inc.), Polyester series (manufactured and sold by Nippon Synthetic Chemical Industry Co., Ltd.), Vylonal series (manufactured and sold by Toyobo Co., Ltd.), Pluscoat series (manufactured and sold by Goo Chemical Co., Ltd.) and Pesresin series (manufactured and sold by Takamatsu Oil & Fat Co., Ltd.).

The water-dispersible acrylic resin is not restricted and may be properly selected from conventional resins which are properly synthesized or commercially available. Examples of the water-dispersible polyester resin which is commercially available include Hiros XE and PE series (manufactured and sold by Seiko Chemical Industries Co., Ltd.), Bon coat series (manufactured and sold by Dainippon Ink & Chemicals Inc.) and Johncryl series (manufactured and sold by Johnson Polymer Inc.).

The amount of the thermoplastic resin in the image-receiving layer is preferably 50% by mass or more, more preferably from 50 to 90% by mass, based on the mass of the image-receiving layer.

When the image-receiving layer in the image-recording layer is a toner image-receiving layer, it is preferred that the toner image-receiving layer comprises a wax having a melting point of from 70 to 100° C. and the amount of the wax in the toner image-receiving layer is preferably from 1 to 20% by mass, based on the mass of the toner image-receiving layer. With respect to the wax, detailed explanations are given below.

Further, it is preferred that the treatment of fixing-brightening the toner in the toner image-receiving layer is performed using a fixing unit of the image by smoothing the image surface equipped with a heating-pressing unit, a belt and a cooling unit. When the image is formed in the label sheet according to the electrophotography and is fixed; and the label sheet is peeled from the belt, by an usual 2-rools fixing, an adhesion strength between the surface of the roll and the surface of the image-receiving layer may be larger than an adhesion strength between the adhesive layer and the peeling treating layer, so that a disadvantage is likely to be caused wherein the adhesive layer is peeled from the peeling treating layer. Then, examples of the method for lowering the adhesion strength between the surface of the roll and the surface of the image-receiving layer include a method for incorporating a wax in the composition of the toner image-receiving layer and a method for fixing the image using a fixing unit of the image by smoothing the image surface. With respect to the method for forming the image, detailed explanations are given below.

The breaking extension of the image-recording layer is preferably 10% or less, more preferably from 0.1 to 10% and is smaller than that of the intermediate layer or the adhesive layer.

The thickness of the image-recording layer is preferably from 1 to 50 μm, more preferably from 5 to 15 μm.

Hereinbelow, with respect to the image-recording label sheet for the electrophotography comprising a layer which comprises the toner image-receiving layer and the toner (hereinafter, sometimes referred to as “label sheet for the electrophotography”), detailed explanations are given.

<Toner Image-Receiving Layer>

The toner image-receiving layer receives a color toner and a black toner, and forms the image. At a transferring operation, the toner image-receiving layer receives the toner for forming the image by (static) electricity, pressure and the like, from a developing drum or an intermediate transfer body. At a fixing operation, the toner image-receiving layer fixes the toner by heat, pressure and the like.

The toner image-receiving layer comprises at least a thermoplastic resin and optionally other components. As the thermoplastic resin, at least one of a water-soluble resin and a water-dispersible resin which have a glass transition temperature (Tg) of from 40 to 100° C. is preferred. Among these resins, a water-dispersible polyester resin and a water-dispersible acryl resin are preferred. For the toner image-receiving layer, the same water-dispersible polyester resin or water-dispersible acryl resin as that used for the image-recording layer, may be used.

The toner image-receiving layer may comprise other thermoplastic resins so long as the object of the present invention is impaired. Examples of the other thermoplastic resins include thermoplastic resins described in items from (1) to (9) in the section of Coated Paper of Base.

The toner image-receiving layer may comprise, besides the above-noted thermoplastic resins, various additives for improving thermodynamic properties of the toner image-receiving layer. Examples of the additives include releasing agent, plasticizer, colorant, filler, cross-linking agent, charge control agent, emulsifier and dispersant.

—Releasing Agent—

The releasing agent is incorporated in the composition of the toner image-receiving layer so as to prevent offset of the toner image-receiving layer. The releasing agent of the present invention is not restricted and may be properly selected depending on the application so long as it is melted or fused by heating at an image-fixing temperature, is deposited on the surface of the toner image-receiving layer and forms a layer of the releasing agent on the surface by cooling and solidifying.

The releasing agent can be at least one of silicone compounds, fluorine compounds, waxes, and matting agents. As the releasing agent, the compounds described in literatures, for example, “Properties and Applications of Waxes, Revised Edition” (published by Saiwai Shobo) and “The Silicon Handbook” (published by THE NIKKAN KOGYO SHIMBUN) may be used. Further, the silicon compounds, fluorine compounds or waxes used for the toners may be also used, wherein the toners are described in the following patent document:JP-B Nos. 59-38581, 04-32380, Japanese Patent Nos. 2838498 and 2949558, JP-A Nos. 50-117433, 52-52640, 57-148755, 61-62056, 61-62057, 61-118760, 02-42451, 03-41465, 04-212175, 04-214570, 04-263267, 05-34966, 05-119514, 06-59502, 06-161150, 06-175396, 06-219040, 06-230600, 06-295093, 07-36210, 07-43940, 07-56387, 07-56390, 07-64335, 07-199681, 07-223362, 07-287413, 08-184992, 08-227180, 08-248671, 08-248799, 08-248801, 08-278663, 09-152739, 09-160278, 09-185181, 09-319139, 09-319143, 10-20549, 10-48889, 10-198069, 10-207116, 11-2917, 11-44969, 11-65156, 11-73049 and 11-194542. These compounds may be used in combination.

Examples of the silicone compound include a silicone oil, a silicone rubber, a silicone fine particle, a silicone-modified resin and a reactive silicone compound.

Examples of the silicone oil include an unmodified silicon oil, an amino-modified silicone oil, a carboxy-modified silicone oil, a carbinol-modified silicone oil, a vinyl-modified silicone oil, an epoxy-modified silicone oil, a polyether-modified silicone oil, a silanol-modified silicone oil, a methacrylic-modified silicone oil, a mercapto-modified-silicone oil, an alcohol-modified silicone oil, an alkyl-modified silicone oil and a fluorine-modified silicone oil.

Examples of the silicone-modified resin include a silicone-modified resin produced by silicone-modifying a resin such as an olefinic resin, a polyester resin, a vinyl resin, a polyamide resin, a cellulose resin, a phenoxy resin, a vinyl chloride-vinyl acetate resin, an urethane resin, an acrylic resin, a styrene-acrylic resin or a copolymer resin thereof.

The fluorine compound is not restricted and may be properly selected depending on the application. Examples of the fluorine compound include a fluorocarbon oil, a fluorocarbon rubber, a fluorine-modified resin, a fluorosulfonic acid compound, a fluorosulfonic acid, a fluoric acid compound and salts thereof and an inorganic fluoride.

The wax is generally classified into the natural wax and the synthetic wax.

Preferred examples of the natural wax include a vegetable wax, an animal wax, a mineral wax and a petroleum wax. Among them, the vegetable wax is particularly preferred. As the natural wax, particularly from the viewpoint of the compatibility of the wax with a water-dispersible resin used as a material for producing the toner image-receiving layer, a water-dispersible natural wax is preferred.

The vegetable wax is not restricted and may be properly selected from conventional vegetable waxes which are properly synthesized or commercially available. Examples of the vegetable wax include a carnauba wax, a castor oil, a rape oil, a soybean oil, a Japan tallow, a cotton wax, a rice wax, a sugarcane wax, a candelilla wax, a Japan wax and a jojoba oil.

Examples of the carnauba wax which is commercially available include EMUSTAR-0413 (manufactured and sold by Nippon Seiro Co., Ltd.) and SELOSOL 524 (manufactured and sold by Chukyo Yushi Co., Ltd.). Examples of the castor oil which is commercially available include a purified castor oil (manufactured and sold by Itoh Oil Chemicals Co., Ltd).

Among them, particularly from the viewpoint of such excellent property 10 that the image-recording label sheet which comprises the toner image-receiving layer comprising the wax is excellent in anti-offset properties, adhesion resistance, conveyability and glossness, the crazing is hardly caused on the label sheet and the label sheet can be a material for the electrophotography on which a high-quality image can be formed, the carnauba wax having a melting point of from 70 to 95° C. is particularly preferred.

The animal wax is not restricted and may be properly selected from conventional animal waxes. Examples of the animal wax include a beeswax, a lanolin, a spermaceti wax, a whale oil and a wool wax.

The mineral wax is not restricted and may be properly selected form conventional mineral waxes which are commercially available or properly synthesized. Examples of the mineral wax include a montan wax, a montan ester wax, an ozokerite and a ceresin.

Among them, particularly from the viewpoint of such excellent property that the image-recording label sheet which comprises the toner image-receiving layer comprising the wax is excellent in anti-offset properties, adhesion resistance, conveyability and glossness, the crazing is hardly caused on the label sheet and the label sheet can be a material for the electrophotography on which a high-quality image can be formed, the montan wax having a melting point of from 70 to 95° C. is particularly preferred.

The petroleum wax is not restricted and may be properly selected conventional petroleum waxes which are commercially available or properly synthesized. Examples of the petroleum wax include a paraffin wax, a microcrystalline wax and a petrolatum.

The amount of the natural wax in the toner image-receiving layer is preferably from 0.1 to 4 g/m², more preferably from 0.2 to 2 g/m².

When the amount is less than 0.1 g/m², the anti-offset properties and the adhesion resistance of the label sheet may be remarkably poor. On the other hand, when the amount is more than 4 g/m², the quality of the image formed on the label sheet may be poor due to excessive wax.

The melting point of the natural wax is, particularly from the viewpoint of the anti-offset properties and the conveyability of the label sheet, preferably from 70 to 95° C., more preferably from 75 to 90° C.

The synthetic wax is classified into a synthetic hydrocarbon, a modified wax, a hydrogenated wax, and other synthetic waxes produced from fats and oils. As the synthetic wax, from the viewpoint of the compatibility of the wax with a water-dispersible resin used as a material for producing the toner image-receiving layer, a water-dispersible synthetic wax is preferred.

Examples of the synthetic hydrocarbon include a Fischer-Tropsch wax and a polyethylene wax.

Examples of the synthetic wax produced from fats and oils include acid amide (such as stearamide) and acid imide (such as anhydrous phthalimide).

The modified wax is not restricted and may be properly selected depending on the application. Examples of the modified wax include an amine-modified wax, an acrylic acid-modified wax, a fluorine-modified wax, an olefin-modified wax, a urethane-type wax and an alcohol-type wax.

The hydrogenated wax is not restricted and may be properly selected depending on the application. Examples of the hydrogenated wax include a hard castor oil, a castor oil derivative, stearic acid, lauric acid, myristic acid, palmitic acid, behenic acid, sebacic acid, undecylenic acid, heptyl acid, maleic acid and a highly maleinated oil.

The melting point of the releasing agent is, particularly from the viewpoint of the anti-offset properties and the conbeyability of the label sheet, preferably from 70 to 95° C., more preferably from 75 to 90° C.

As the releasing agent incorporated in the composition of the toner image-receiving layer, a derivative, an oxide, a purified product and a mixture of the above-exemplified releasing agent may be also used. These releasing agents may have a reactive substituent.

The amount of the releasing agent in the toner image-receiving layer is preferably from 0.1 to 10% by mass, more preferably from 0.3 to 8.0% by mass, still more preferably from 0.5to 5.0% by mass, based on the mass of the toner image-receiving layer.

—Plasticizer—

The plasticizer is not restricted and may be properly selected from conventional plasticizers depending on the application. The plasticizer has the function to control the fluidizing and softening of the toner image-receiving layer due to the heat and pressure applied on the layer during fixing the toner.

Examples of a reference for selecting the plasticizer include literatures, such as “Kagaku Binran (Chemical Handbook)” (edited by The Chemical Society of Japan and published by Maruzen Co., Ltd.), “Plasticizer, Theory and Application” (edited by Koichi Murai and published by Saiwai Shobo), “Volumes 1 and 2 of Studies on Plasticizer” (edited by Polymer Chemistry Association) and “Handbook on Compounding Ingredients for Rubbers and Plastics” (edited by Rubber Digest Co.).

Some plasticizers are described as a high-boiling point organic solvent or a thermal solvent in some literatures. Examples of the plasticizer including esters (such as phthalate esters, phosphorate esters, fatty esters, abietate esters, adipate esters, sebacate esters, azelate esters, benzoate esters, butyrate esters, epoxidized fatty esters, glycolate esters, propionate esters, trimellitate esters, citrate esters, sulfonate esters, carboxylate esters, succinate esters, malate esters, fumarate esters, phthalate esters and stearate esters), amides (such as aliphatate amides and sulfonate amides); ethers; alcohols; lactones and polyethylene oxides which are described in patent documents, such as JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, and 2-235694.

These plasticizers may be incorporated in the composition of the resin.

Further, a plasticizer having a relatively low molecular weight can be also used. The molecular weight of such a plasticizer is preferably lower than that of a binder resin which is plasticized and is preferably 15,000 or less, more preferably 5,000 or less. In addition, when a plasticizer is a polymer, the plasticizer is preferably a polymer of the same type as that of the binder resin which is plasticized by the plasticizer. For example, for plasticizing a polyester resin, the plasticizer is preferably a polyester having a low molecular weight. Further, an oligomer can be also used as a plasticizer.

Besides the above-noted compounds, examples of the plasticizer include compounds which are commercially available, such as Adekacizer PN-170 and PN-1430 (manufactured and sold by Asahi Denka Kogyo Co., Ltd.), PARAPLEX G-25, G-30 and G40 (manufactured and sold by C.P. Hall Co.) and Ester Gum 8L-JA, Ester R-95, Pentalin 4851, FK 115, 4820, 830, Luisol 28-JA, Picolastic A75, Picotex LC and Crystalex 3085 (manufactured and sold by Rika Hercules Co.)

The plasticizer can be arbitrarily used for mitigating the stress and strain which may be caused when the toner particles are embedded in the toner image-receiving layer, wherein examples of the strain include physical strain, such as elastic force and viscosity and strain due to material balance in molecules, principal chains and pendant moieties of the binder.

The plasticizer may be finely (microscopically) dispersed, may undergo micro-phase separation into islands-in-sea structure and may be compatibilized with other components, such as a binder.

The amount of the plasticizer in the toner image-receiving layer is preferably from 0.001 to 90% by mass, more preferably from 0.1 to 60% by mass, still more preferably from 1 to 40% by mass, based on the mass of the toner image-receiving layer.

The plasticizer can be used for the object of controlling the slipping property (leading to the improvement of the conveyability due to reduction of the friction), improving the offset property during fixing (peeling of the toner or a layer onto the fixing portion), controlling the curling balance and controlling the charging property (latent toner image formation).

—Colorant—

The colorant is not restricted and may be properly selected depending on the application. Examples of the colorant include a fluorescent whitening agent, a white pigment, a colored pigment and a dye.

The fluorescent whitening agent is not restricted so long as the agent is a conventional compound having absorption in the near-ultraviolet region and emitting a fluorescence having a wavelength of from 400 to 500 nm and may be properly selected from conventional fluorescent whitening agents. Preferred examples of the fluorescent whitening agent include the compounds described in the literature “The Chemistry of Synthetic Dyes, Volume V, Chapter 8 ” (edited by K. Veen Rataraman). The fluorescent whitening agent may be any commercially available product and properly synthesized product. Examples of the fluorescent whitening agent include stilbene compounds, coumarin compounds, biphenyl compounds, benzo-oxazoline compounds, naphthalimide compounds, pyrazoline compounds and carbostyril compounds. Examples of the commercially available fluorescent whitening agent include white furfar-PSN, PHR, HCS, PCS, B (manufactured and sold by Sumitomo Chemicals Co., Ltd.) and UVITEX-OB (manufactured and sold by Ciba-Geigy Corp.).

The white pigment is not restricted and may be properly selected from conventional white pigments depending on the application. Examples of the white pigment include an inorganic pigment, such as titanium oxide and calcium carbonate.

The colored pigment is not restricted and may be properly selected from conventional colored pigments. Examples of the colored pigment include various pigments described in JP-A No. 63-44653 and the like, an azo pigment, a polycyclic pigment, a condensed polycyclic pigment, a lake pigment and a carbon black.

Examples of the azo pigment include an azo lake (, such as carmine 6B and red 2B), an insoluble azo pigment (, such as monoazo yellow, disazo yellow, pyrazolone orange and Vulcan orange) and a condensed azo compound (, such as chromophthal yellow and chromophthal red).

Examples of the polycyclic pigment include a phthalocyanine pigment, such as copper phthalocyanine blue and copper phthalocyanine green.

Examples of the condensed polycyclic pigment include dioxazine pigments (, such as dioxazine violet), isoindolinone pigments(, such as isoindolinone yellow), threne pigments, perylene pigments, perinone pigments and thioindigo pigments.

Examples of the lake pigment include malachite green, rhodamine B, rhodamine G and Victoria blue B.

Examples of the inorganic pigment include an oxide (, such as titanium dioxide and iron oxide red), a sulfate (, such as precipitated barium sulfate), a carbonate (, such as precipitated calcium carbonate) a silicate (, such as a hydrous silicate and an anhydrous silicate) and a metal powder (, such as aluminum powder, bronze powder, zinc powder, chrome yellow and iron blue).

These pigments can be used individually or in combination.

The dye is not restricted and may be properly selected from conventional dyes depending on the application. Examples of the dye include anthraquinone compounds and azo compounds. These dyes can be used individually or in combination.

Examples of the water-insoluble dye include a vat dye, a disperse dye and an oil-soluble dye. Specific examples of the vat dye include C. I. Vat violet 1, C. I. Vat violet 2, C. I. Vat violet 9, C. I. Vat violet 13, C. I. Vat violet 21, C. I. Vat blue 1, C. I. Vat blue 3, C. I. Vat blue 4, C. I. Vat blue 6, C. I. Vat blue 14, C. I. Vat blue 20 and C. I. Vat blue 35. Specific examples of the disperse dye include C. I. disperse violet 1, C. I. disperse violet 4, C. I. disperse violet 10, C. I. disperse blue 3, C. I. disperse blue 7 and C. I. disperse blue 58. Examples of the oil-soluble dye include C. I. solvent violet 13, C. I. solvent violet 14, C. I. solvent violet 21, C. I. solvent violet 27, C. I. solvent blue 11, C. I. solvent blue 12, C. I. solvent blue 25 and C. I. solvent blue 55.

Colored couplers used in silver halide photography may also be used preferably as the dye.

The amount of the colorant in the toner image-receiving layer is preferably 0.1 to 8 g/m², more preferably 0.5 to 5 g/m².

When the amount of the colorant is less than 0.1 g/m², the light transmittance in the toner image-receiving layer may be high. On the other hand, when the amount is more than 8 g/m², handling properties, such as crazing and adhesion resistance may be impaired.

The amount of the pigment is preferably 40% by mass or less, more preferably 30% by mass or less, still more preferably 20% by mass or less, based on the mass of the thermoplastic resin in the toner image-receiving layer.

Examples of the filler include an organic filler and an inorganic filler which are conventional as a reinforcer for the binder resin, a bulking agent or a reinforcing agent. The filler may be selected by referring to “Handbook of Rubber and Plastics Additives” (edited by Rubber Digest Co.), “Plastics Blending Agents-Basics and Applications” (New Edition) (published by Taisei Co.) and “The Filler Handbook” (published by Taisei Co.).

Examples of the filler include an inorganic filler and an inorganic pigment. Specific examples of the inorganic filler or the inorganic pigment include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate and mullite. Among them, silica and alumina are particularly preferred. These fillers may be used individually or in combination. It is preferred that the filler has a small particle diameter. When the particle diameter of the filler is large, the surface of the toner image-receiving layer is easily roughened.

Examples of the silica include a spherical silica and an amorphous silica. The silica can be synthesized by a dry method, a wet method and an aerogel method. The silica may be also produced by treating the surface of the hydrophobic silica particle with a trimethylsilyl group or silicone. Preferred examples of the silica include a colloidal silica. The silica is preferably porous.

Examples of the alumina include an anhydrous alumina and a hydrated alumina. Examples of the crystallized anhydrous alumina include α-, β-, γ-, δ-, ξ-, η-, θ-, κ-, ρ- and χ-anhydrous alumina. The hydrated alumina is more preferred than the anhydrous alumina. Examples of the hydrated alumina include a monohydrated alumina and a trihydrate alumina. Examples of the monohydrated alumina include pseudo-boehmite, boehmite and diaspore. Examples of the trihydrated alumina include gibbsite and bayerite. The alumina is preferably porous.

The hydrated alumina can be synthesized by the sol-gel method in which ammonia is added to a solution of an aluminum salt to precipitate alumina or by a method of hydrolyzing an alkali aluminate. The anhydrous alumina can be obtained by heating to dehydrate a hydrated alumina.

The amount of the filler is preferably from 5 to 2000parts by mass, relative to 100 parts by mass of the dry weight of the binder resin in the toner image-receiving layer.

The crosslinking agent may be incorporated in the resin composition of the toner image-receiving layer for controlling the shelf stability and thermoplasticity of the toner image-receiving layer. Examples of the crosslinking agent include a compound containing in the molecule two or more reactive groups selected from the group consisting of an epoxy group, an isocyanate group, an aldehyde group, an active halogen group, an active methylene group, an acetylene group and other conventional reactive groups.

Examples of the crosslinking agent include also a compound having two or more groups which can form a bond through a hydrogen bond, an ionic bond or a coordination bond.

Further, examples of the crosslinking agent include a conventional compound as a coupling agent for the resin, a curing agent, a polymerizing agent, a polymerization promoter, a coagulant, a film-forming agent and a film-forming assistant. Examples of the coupling agent include chlorosilanes, vinylsilanes, epoxisilanes, aminosilanes, alkoxy aluminum chelates, titanate coupling agents and other conventional agents described in the literature “Handbook of Rubber and Plastics Additives” (edited by Rubber Digest Co.).

The toner image-receiving layer preferably comprises a charge control agent for controlling the transfer and adhesion of the toner and for preventing the adhesion caused by the charge of the toner image-receiving layer.

The charge control agent is not restricted and may be properly selected from conventional various charge control agents depending on the application. Examples of the charge control agent include a surfactant, such as a cationic surfactant, an anionic surfactant, an amphoteric surfactant and a non-ionic surfactant; a polymer electrolyte and a conductive metal oxide. Specific examples of the charge control agent include a cationic antistatic agent, such as a quaternary ammonium salt, a polyamine derivative, a cation-modified polymethyl methacrylate, a cation-modified polystyrene; an anionic antistatic agent, such as an alkyl phosphate and an anionic polymer; and a non-ionic antistatic agent, such as a fatty ester and a polyethylene oxide.

When the toner is negatively charged, the charge control agent in the toner image-receiving layer is preferably a cationic or nonionic charge control agent.

Examples of the conductive metal oxide include ZnO, TiO₂, SnO_{2,} Al₂O₃, In₂O₃, SiO₂, MgO, BaO and MoO₃. These conductive metal oxides may be used individually or in combination. The conductive metal oxide may contain (dope) other elements, for example, ZnO may contain Al, In, TiO₂ may contain Nb, Ta and SnO₂ may contain Sb, Nb and a halogen element.

—Other Additives—

The toner image-receiving layer of the present invention may comprise various additives for improving stability of the output image or improving stability of the toner image-receiving layer itself. Examples of the additive include various conventional antioxidants, age resisters, degradation inhibitors, anti-ozone degradation inhibitors, ultraviolet light absorbers, metal complexes, light stabilizers, antiseptic agents and anti-fungus agents.

The antioxidant is not restricted and may be properly selected depending on the application. Examples of the antioxidant in a chroman compound, a coumarane compound, a phenol compound (e.g., a hindered phenol), a hydroquinone derivative, a hindered amine derivative and a spiroindan compound. With respect to the antioxidant, there is described in the patent document JP-A No. 61-159644.

The age resister is not restricted and may be properly selected depending on the application. Examples of the age resister include age resisters described in the literature “Handbook of Rubber and Plastics Additives-Second Edition” (published by Rubber Digest Co., 1993 (p76-121)).

The ultraviolet light absorber is not restricted and may be properly selected depending on the application. Examples of the ultraviolet light absorber include a benzotriazo compound (see U.S. Pat. No. 3,533,794), a 4-thiazolidone compound (see U.S. Pat. No. 3,352,681), a benzophenone compound (see JP-A No. 46-2784) and a ultraviolet light absorbing polymer (see JP-A No. 62-260152).

The metal complex is not restricted and may be properly selected depending on the application. Examples of the metal complex include metal complexes described in patent documents, such as U.S. Pat. Nos. 4,241,155, 4,245,018, and 4,254,195; and JP-A Nos. 61-88256, 62-174741, 63-199248, 01-75568, and 01-74272.

Also, ultraviolet absorbers and light stabilizers described in the literature “Handbook on Compounding Ingredients for Rubbers and Plastics, revised second edition, p. 122-137 (1993)” (published by Rubber Digest Co.) can be preferably used.

In the composition of the toner image-receiving layer, as noted above, a conventional additive for photography may be optionally incorporated. Examples of the additive for photography include additives described in the literature “Journal of Research Disclosure (hereinafter referred to as RD) No. 17643 (December 1978), No. 18716 (November 1979) and No. 307105 (November 1989)”. These additives are specifically noted on Table 1 as follows.

TABLE 1

| Type of additives | | RD17643 | RD18716 | RD307105 |
|---|---|---|---|---|
| 1. | Whitening agent | pp.24 | p.648 right column | p.868 |
| 2. | Stabilizer | pp.24-25 | p.649 right column | pp.868-870 |
| 3. | Light absorber | pp.25-26 | p.649 right column | p.873 |
| | (Ultraviolet light | | | |
| | absorber) | | | |
| 4. | Dye image stabilizer | p.25 | p.650 right column | p.872 |
| 5. | Film hardener | p.26 | p.651 left column | pp.874-875 |
| 6. | Binder | p.26 | p.651 left column | pp.873-874 |
| 7. | Plasticizer, lubricant | p.27 | p.650 right column | p.876 |
| 8. | Auxiliary coating | pp.26-27 | p.650 right column | pp.875-876 |
| | agent (Surfactant) | | | |
| 9. | Antistatic agent | p.27 | p.650 right column | pp.876-877 |
| 10. | Matting agent | | | pp.878-879 |

The toner image-receiving layer of the present invention is disposed on the base by coating the base with the coating liquid containing a thermoplastic resin for the toner image-receiving layer by means of a wire coater and by drying the resultant coating. The molding film temperature (MFT) of the thermoplastic resin according to the present invention is preferably room temperature or higher for the preservation of the label sheet before the print and preferably 100° C. or lower for fixing the toner particles.

The mass of the dried coating as the toner image-receiving layer is preferably from 1 to 20 g/m², more preferably from 4 to 15 g/m². The thickness of the toner image-receiving layer is preferably from 1 to 50 μm, more preferably from 1 to 30 μm, still more preferably from 2 to 20 μm, most preferably from 5 to 15 μm.

[Physical Properties of Toner Image-Receiving Layer] The 180-degree peel strength of the toner image-receiving layer at the image-fixing temperature at which the image is fixed on the fixing member is preferably 0.1 N/25 mm or less, more preferably 0.041 N/25 mm or less. The 180-degree peel strength can be determined according to a method described in JIS K 6887 using a surface material of the fixing member.

It is preferred that the toner image-receiving layer has a high degree of whiteness. The whiteness is measured by the method described in JIS P 8123 and is preferably 85% or more. It is preferred that the spectral reflectance of the toner image-receiving layer is 85% or more in the wavelength range of from 440 to 640 nm and the difference between the maximum spectral reflectance of the layer and the minimum spectral reflectance of the layer in the above-noted wavelength range is within 5%. Further, it is preferred that the spectral reflectance of the layer is 85% or more in the wavelength range of from 400 to 700 nm and the difference between the maximum spectral reflectance of the layer and the minimum spectral reflectance of the layer in the above-noted wavelength range is within 5%.

With respect to the whiteness of the toner image-receiving layer, specifically, in the CIE 1976 (L* a* b*) color space, an L* value is preferably 80 or more, more preferably 85 or more, still more preferably 90 or more. The tone of the whiteness is preferably as neutral as possible. With respect to the tone of the whiteness, in the (L* a* b*) space, the value of (a*)² +(b*)² is preferably 50 or less, more preferably 18 or less, still more preferably 5 or less.

It is preferred that the toner image-receiving layer has a high glossiness after the image-forming. With respect to the glossiness of the layer, through the range of from the state in which the layer is white, i.e., there is no toner in the layer to the state in which the layer is black, i.e., there is full of the toner in the layer, the 45-degree glossiness of the layer is preferably 60 or more, more preferably 75 or more, still more preferably 90 or more.

However, the glossiness of the layer is preferably 110 or less. When the glossiness is more than 110, the image has a metallic luster and such a quality of the image is undesirable.

The glossiness can be measured according to JIS Z 8741.

It is preferred that the toner image-receiving layer has high smoothness after the fixing. With respect to the smoothness of the layer, through the range of from the state in which the layer is white, i.e., there is no toner in the layer to the state in which the layer is black, i.e., there is full of the toner in the layer, the arithmetic average roughness (Ra) of the layer is preferably 3 μm or less, more preferably 1 μm or less, still more preferably 0.5 μm or less.

The arithmetic average roughness can be measured, for example, according to JIS B 0601, B 0651 and B 0652.

The toner image-receiving layer has preferably one of the physical properties described in the following items (1) to (6), more preferably several of them, most preferably all of them.
(1) Tm (melting temperature) of the toner image-receiving layer is preferably 30° C. or more, more preferably a temperature which is higher than Tm of the toner by 20° C., or lower.
(2) The temperature at which the viscosity of the toner image-receiving layer is 1×10⁵ cp is preferably 40° C. or higher, more preferably a temperature which is lower than the corresponding temperature of the toner.
(3) At the fixing temperature of the toner image-receiving layer, the storage elasticity modulus (G′) of the layer is preferably from 1×10² to 1×10⁵ Pa, the loss elasticity modulus (G″) of the layer is preferably from 1×10² to 1×10⁵ Pa.
(4) At the fixing temperature of the toner image-receiving layer, the loss tangent (G″/G′) which is the ratio of the loss elasticity modulus (G″) to the storage elasticity modulus (G′) is preferably from 0.01 to 10.
(5) The storage elasticity modulus (G′) of the toner image-receiving layer at the fixing temperature is larger than the storage elasticity modulus (G′) of the toner at the fixing temperature, preferably by from −50 to +2500.
(6) The inclination angle of the molten toner on the toner image-receiving layer is preferably 50° or less, more preferably 40° or less.

The toner image-receiving layer preferably satisfies the physical properties described in the patent documents, such as Japanese Patent No. 2788358 and JP-A Nos. 07-248637, 08-305067 and 10-239889.

It is preferred that the surface electrical resistance of the toner image-receiving layer is in the range of from 1×10⁶ to 1×10¹⁵ Ω/cm² (under conditions of 25° C. and 65% RH).

When the surface electrical resistance is less than 1×10⁶ Ω/cm², the amount of the toner transferred to the toner image-receiving layer is unsatisfactory, so that a disadvantage is likely to be caused wherein the density of the toner image obtained may be too low. On the other hand, when the surface electrical resistance is more than 1×10¹⁵ Ω/cm², more charge than the necessity is generated during the transfer, so that the toner is transferred unsatisfactorily, the image density is low and the electrophotographic image-receiving label sheet is electrostatically charged, so that the sheet adsorbs easily the dust. Moreover, in this case, miss field, multi feed, discharge marks and toner transfer dropout may occur during the copying.

The surface electrical resistance of the toner image-receiving layer can be measured according to JIS K 6911 as follows. The sample of the toner image-receiving layer is left under the condition where the temperature is 20° C. and the humidity is 65% for 8 hours or more. Under the same condition as the above-noted condition, the surface electrical resistance can be measured using a micro-ammeter R8340 (manufactured and sold by Advantest Ltd.) at 1 minute after applying a voltage of 100 V to the sample of the toner image-receiving layer.

<Toner>

The electrophotographic image-receiving sheet of the present invention is used by allowing the toner image-receiving layer to receive the toner during printing and copying.

The toner comprises at least a binder resin and a colorant and optionally a releasing agent and other components.

—Toner's Binder Resin—

The binder resin is not restricted and may be properly selected from binder resins used usually for the toner depending on the application. Examples of the binder resin include vinyl monopolymer of: styrenes, such as styrene and parachlorostyrene; vinyl esters, such as vinyl naphthalene, vinyl chloride, vinyl bromide, vinyl fluoride, vinyl acetate, vinyl propioniate, vinyl benzoate and vinyl butyrate; methylene aliphatic carboxylates, such as methyl acrylate, ethyl acrylate, n-butyl acrylate, isobutyl acrylate, dodecyl acrylate, n-octyl acrylate, 2-chloroethyl acrylate, phenyl acrylate, α-methyl chloroacrylate, methyl methacrylate, ethyl methacrylate and butyl acrylate; vinyl nitriles, such as acrylonitrile, methacrylonitrile and acrylamide; vinyl ethers, such as vinyl methyl ether, vinyl ethyl ether and vinyl isobutyl ether; N-vinyl compounds, such as N-vinyl pyrrole, N-vinylcarbazole, N-vinyl indole and N-vinyl pyrrolidone; and vinyl carboxylic acids, such as methacrylic acid, acrylic acid and cinnamic acid. These vinyl monomers may be used either alone, or copolymers thereof may be used. Further, various polyesters may be used, and various waxes may be used in combination.

Among these resins, it is preferable to use a resin same as that used for the toner image-receiving layer of the present invention.

—Toner's colorant—

The colorant is not restricted and may be properly selected from colorants used usually for the toner depending on the application. Examples of the colorant include various kinds of pigments, such as carbon black, chrome yellow, Hansa yellow, Benzidine Yellow, threne yellow, quinoline yellow, permanent orange GTR, pyrazolone orange, Vulcan orange, watch young red, permanent red, brilliant carmine 3B, brilliant carmine 6B, dippon oil red, pyrazolone red, lithol red, rhodamine B lake, lake red C, Rose Bengale, aniline blue, ultramarine blue, chalco oil blue, methylene blue chloride, phthalocyanine blue, phthalocyanine green, malachite green oxalate. Other examples include various kinds of dyes, such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenyl methane dyes, diphenyl methane dyes, thiazine dyes, thiazole dyes, xanthene dyes and the like.

These colorants may be used individually or in combination.

The amount of the colorant is not restricted and may be properly selected depending on the application. The amount is preferably 2% to 8% by mass, based on the mass of the toner. When the amount of the colorant is less than 2% by mass, the coloring power of the toner may be weakened. On the other hand, when the amount is more than 8% by mass, the clarity of the toner may be impaired.

—Toner's Releasing Agent—

The releasing agent is not restricted and may be properly selected from releasing agents used usually for the toner depending on the application. Polar waxes containing nitrogen such as highly crystalline polyethylene wax having relatively low molecular weight, Fischertropsch wax, amide wax, urethane wax, and the like are particularly effective.

For polyethylene wax, it is effective when the molecular weight is 1000 or less, and is more preferable when the molecular weight is 300 to 1000.

Since the compounds containing the urethane bonds tend to stay in a solid state due to the strength of the cohesive force of the polar groups even though the molecular weight is low, and since the melting point may be set high for the molecular weight, such compounds are suitable in general. The preferred molecular weight is 300 to 1000. The raw materials may be selected from various combinations such as diisocyanic acid compound with mono-alcohol, monoisocyanic acid with mono-alcohol, dialcohol with mono-isocyanic acid, tri-alcohol with monoisocyanic acid, and triisocyanic acid compound with mono-alcohol. However, in order to prevent the molecular weight from becoming too large, it is preferable to combine a compound having multiple functional groups with another compound having a single functional group, and it is important that the amount of functional groups is equivalent.

Examples of the monoisocyanic acid compound include dodecyl isocyanate (and derivatives thereof), phenyl isocyanate (and derivatives thereof), naphthyl isocyanate, hexyl isocyanate, benzil isocyanate, butyl isocyanate, allyl isocyanate.

Examples of the diisocyanic acid compound include tolylene diisocyanate, 4,4′diphenylmethane diisocyanate, toluene diisocyanate, 1,3-phenylene diisocyanate, hexamethylene diisocyanate, 4-methyl-m-phenylene diisocyanate, isophorone diisocyanate.

Examples of the monoalcohol include methanol, ethanol, propanol, butanol, pentanol, hexanol, heptanol.

Examples of the dialcohol include various glycols such as ethylene glycol, diethylene glycol, triethylene glycol, trimethylene glycol.

Examples of the trialcohol include trimethylol propane, triethylol propane, trimethanol ethane.

Like an ordinary releasing agent, the above urethane compounds can be mixed with resin or colorant during mixing-kneading, to be used as mixed-kneaded-pulverized toner. When used for the toner of the emulsion polymerization cohesive melting method, the urethane compounds are to be dispersed in water in combination with the ion surfactant or high molecular electrolyte (such as high molecular acid or high molecular base), and then heated to the melting point or more, then subjected to a strong shearing caused by homogenizer or pressure discharge type dispersing apparatus for forming fine-particles, to thereby prepare releasing agent particle-containing dispersing liquid (particle: 1 μm or less) which can be used in combination with the resin particle-containing dispersing liquid, the colorant-containing dispersing liquid and the like.

—Other Components of Toner—

The toner may comprise other components, such as an inner additive, a charge control agent and an inorganic fine-particle. Examples of the inner additive include metals such as ferrite, magnetite, reduced iron, cobalt, nickel, manganese; alloy; and magnetic bodies, such as compounds including the above-noted metals.

Examples of the charge control agent include various charge control agents used usually, such as quaternary ammonium salt compounds, nigrosine compounds, dyes made of complexes (such as aluminum, iron and chromeium) and triphenyl methane pigments. It is preferable that the charge control agent is unlikely to be dissolved in water, from the view point of controlling ion strength which may cause an effect on stability during coagulation (cohesion) or melting, and from the viewpoint of reducing waste water pollutant.

Examples of the inorganic fine-particle include all ordinary outer additives of the toner surface, such as silica, alumina, titania, calcium carbonate, magnesium carbonate and tricalcium phosphate. These particles are preferably used in the state in which the particles are dispersed in an ionic surfactant, a polymer acid or a polymer base.

Surfactants may also be used for emulsion polymerization, seed polymerization, pigment dispersion, resin particle dispersion, releasing agent dispersion, coagulation (cohesion) and stabilization thereof. For example, it is effective to use, in combination, anionic surfactants, such as sulfuric acid ester salts, sulfonic acid salts, phosphoric acid esters and soaps; cationic surfactants, such as amine salts and quaternary ammonium salts; and non-ionic surfactants, such as polyethylene glycols, alkylphenol ethylene oxide adducts and polybasic alcohols. These may generally be dispersed by a rotary shear homogenizer. Other dispersing measures include a ball mill, a sand mill and a dyno mill, all of which contain the media.

The toner may comprise optionally an outer additive. Examples of the outer additive include an inorganic particle and an organic particle. Examples of the inorganic particle include SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, Al₂O₃, 2SiO₂, CaCO₃, MgC)₃, BaSO₄, MgSO₄. Examples of the organic particle include fatty acids and derivatives thereof, powders of the above-noted metal salts and resin particles (such as fluorine resin, polyethylene resin, acrylic resin).

The average particle diameter of the above-noted particles is preferably from 0.01 to 5 μm, more preferably from 0.1 to 2 μm.

The process of producing the toner is not restricted and may be properly selected depending on the application. However, it is preferred that the toner is produced by a process comprising the steps of (i) forming cohesive particles in a dispersion of resin particles to prepare a cohesive particle dispersion, (ii) adding a fine particle dispersion to the cohesive particle dispersion so that the fine particles adhere to the cohesive particles, thus forming adhesive particles and (iii) heating the adhesive particles which is then melt to form toner particles.

—Physical Properties of Toner—

The toner preferably has a volume average particle diameter of 0.5 μm to 10 μm. When the volume average particle diameter of the toner is too small, handling properties of the toner (, such as supplying property, cleanability and fluidity) may be affected disadvantageously and the productivity of the particles may be lowered. On the other hand, when the volume average particle diameter of the toner is too large, the quality and resolution of the image attributable to graininess and transferability may be affected disadvantageously.

It is preferable that the toner of the present invention satisfies the above range of volume average particle diameter and has a distribution index of volume average particle diameter (GSDv) of 1.3 or less.

The ratio (GSDv/GSDn) of the distribution index of volume average particle diameter (GSDv) to a distribution index of number average particle diameter (GSDn) is preferably 0.95 or more.

It is preferable that the toner of the present invention satisfies the above range of volume average particle diameter and has an average (1.00 to 1.50) of profile factors given by the following expression.

Profile factor =(π×L²)/(4×S)

(where L denotes the maximum length of toner particle, and S denotes projected area of toner particle)

The toner satisfying the above conditions can bring about an effect on image quality, particularly graininess and resolution. Moreover in this case, dropout or blur which may be caused by transfer is unlikely to occur, and handling may be unlikely to be adversely influenced even when the average particle diameter becomes small.

From the viewpoint of improving image quality and preventing offset during the fixing operation, it is preferred that the toner has storage elasticity modulus G′ (measured at angle frequency of 10 rad/sec) of 1×10² to 1×10⁵ Pa at 150° C.

(Method for Forming Image)

The method for forming the image according to the present invention comprises forming the toner image and fixing the image by smoothing the image surface, and optionally other processes.

—Process for Forming Toner Image—

The process for forming the toner image is a process for forming the toner image on the surface of the toner image-receiving layer of the label sheet for the electrophotography according to the present invention.

The process for forming the toner image is not restricted so long as by the process, the toner image can be formed in the label sheet for the electrophotography, and may be properly selected depending on the application. Examples of the process for forming the toner image include a usual method used for the electrophotography, such as a direct transfer method in which the toner image formed on the developing roller is directly transferred to the label sheet for the electrophotography and an intermediate transfer belt method in which the toner image formed on the developing roller is primary-transferred to the intermediate transfer belt and the primary-transferred image is transferred to the label sheet. From the viewpoint of environmental stability and enhancing the image quality, the intermediate transfer belt method is preferably used.

—Process for Fixing the Image by Smoothing the Image Surface—

The process for fixing the image by smoothing the image surface is a process in which the surface of the toner image formed according to the above-noted process for forming the toner image is smoothed. In the process for fixing the image by smoothing the image surface, using a fixing unit of the image by smoothing the image surface equipped with a heating-pressing unit, a belt and a cooling unit, the toner image is heated, pressed and cooled and the label sheet is peeled from the belt.

The fixing unit of the image by smoothing the image surface comprises a heating-pressing unit, a belt, a cooling unit, a cooling-peeling portion and optionally other units.

The heating-pressing unit is not restricted and may be properly selected depending on the application. Examples of the heating-pressing unit include a pair of heating rollers and a combination of a heating roller and a pressing roller.

The cooling unit is not restricted and may be properly selected depending on the application. Examples of the cooling unit include a cooling unit which can blow a cool air and can control the cooling temperature and a heat sink.

The cooling-peeling portion is not restricted and may be properly selected depending on the application. Examples of the cooling-peeling portion include a section which is near of the tension roller where the label sheet for the electrophotography is peeled from the belt by own stiffness (nerve) of the label sheet.

For contacting the toner image with a heating-pressing unit of the unit for fixing the image by smoothing the image surface, the label sheet is preferably pressed. The method for pressing the label sheet is not restricted and may be properly selected depending on the application; however, a nip pressure is preferably used. The nip pressure is, from the viewpoint of forming an image which is excellent in water resistance and surface smoothness and has advantageous gloss, preferably from 1 to 100 kgf/cm², more preferably from 5 to 30 kgf/cm². The temperature for the heating in the heating-pressing unit is a temperature which is higher than the softening point of the polymer in the toner image-receiving layer and is varied depending on the type of the polymer in the toner image-receiving layer, however is usually preferably from 80 to 200° C. The temperature for the cooling in the cooling unit is preferably a temperature which is not higher than 80° C. at which the polymer layer as the toner image-receiving layer is satisfactorily set, more preferably from 20 to 80° C.

The belt comprises a heat resistant support film and a mold-releasing layer disposed on the support film.

The material for the support film is not restricted so long as the material has heat resistance and may be properly selected depending on the application. Examples of the material include polyimide (PI), polyethylene naphthalate (PEN), polyethylene terephthalate (PET), polyether ether ether ketone (PEEK), polyether sulfone (PES), poly ether imide (PEI) and poly parabanic acid (PPA).

The mold-releasing layer comprises preferably at least one selected from the group consisting of a silicone rubber, a fluorine rubber, a fluorocarbon siloxane rubber, a silicone resin and fluorine resin. Among them, the following aspects i) and ii):

i) a fluorocarbon siloxane rubber layer disposed on the surface of the fixing belt and ii) a silicone rubber layer disposed on the surface of the belt and a fluorocarbon siloxane rubber layer disposed on the surface of the silicone rubber layer,

are preferred.

It is preferred that the fluorocarbon siloxane rubber of the fluorocarbon siloxane rubber layer has, as the backbone chain, at least one of a perfluoroalkyl ether group and a perfluoroalkyl group.

The fluorocarbon siloxane rubber is preferably a cured form of a fluorocarbon siloxane rubber composition comprising the following components (A)-(D):

(A) a fluorocarbon polymer comprising mainly a fluorocarbon siloxane represented by the following formula (1) and having an aliphatic unsaturated group, (B) at least one of organopolysiloxane and fluorocarbon siloxane which have two or more ≡SiH groups in one molecule, wherein the amount of a ≡SiH group is from one to four times (in mole) the amount of the aliphatic unsaturated group in the fluorocarbon siloxane rubber composition, (C) a filler, and (D) an effective amount of catalyst.

The fluorocarbon polymer of the component (A) comprises mainly a fluorocarbon siloxane containing a recurring unit represented by the following formula (1) and contains an aliphatic unsaturated group.

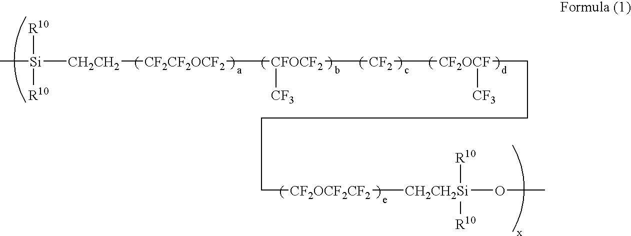

In formula (1), R¹⁰ represents an unsubstituted or substituted C₁-C₈ monovalent hydrocarbon group and is preferably a C₁-C₈ alkyl group or a C₂-C₃ alkenyl group, most preferably a methyl group. a and e are respectively an integer of 0 or 1, b and d are respectively an integer of 1 to 4 and c is an integer of 0 to 8. x is preferably an integer of 1 or more, more preferably an integer of 10 to 30.

Examples of the component (A) include a compound represented by the following formula (2):

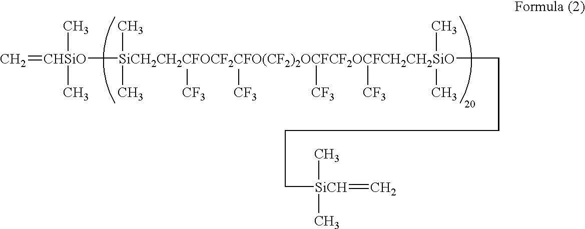

With respect to the component (B), examples of the organopolysiloxane having ≡SiH groups include an organohydrogen polysiloxane having in the molecule at least two hydrogen atoms bonded to a silicon atom.

In the fluorocarbon siloxane rubber composition, when the fluorocarbon polymer of the component (A) has an aliphatic unsaturated group, as a curing agent, the above-noted organohydrogen polysiloxane is preferably used. In other words, the cured form is produced by an addition reaction between the aliphatic unsaturated group of the fluorocarbon siloxane and a hydrogen atom bonded to a silicon atom in the organohydrogen polysiloxane.

As the organohydrogen polysiloxane, various organohydrogen polysiloxanes used for curing a silicone rubber composition which is cured by an addition reaction can be used.

The amount of the organohydrogen polysiloxane is an amount by which the number of ≡SiH groups in the organohydrogen polysiloxane is preferably at least one, most preferably from 1 to 5, relative to one aliphatic unsaturated hydrocarbon group in the fluorocarbon siloxane of the component (A).

Also, with respect to the component (B), examples of the fluorocarbon siloxane having the ≡SiH groups include a fluorocarbon siloxane having a structure of the recurring unit represented by the formula (1) and a fluorocarbon siloxane having a structure of the recurring unit represented by the formula (1) in which R¹⁰ is a dialkylhydrogen siloxane group and the terminal group is a ≡SiH group, such as dialkylhydrogen siloxane group or silyl group. Such a preferred 10 fluorocarbon can be represented by the following formula (3).

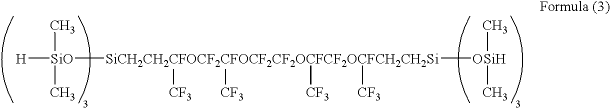

As the filler which is the component (C), various fillers used for a usual silicone rubber composition can be used. Examples of the filler include a reinforcing filler, such as a mist silica, a precipitated silica, a carbon powder, titanium dioxide, aluminum oxide, a quartz powder, talc, sericite and bentonite; and a fiber filler, such as an asbesto, a glass fiber, and an organic fiber.

Examples of the catalyst which is the component (D) include chloroplatinic acid; alcohol-modified chloroplatinic acid; a complex of chloroplatinic acid and an olefin; platinum black or palladium supported on a carrier, such as alumina, silica and carbon; and a element belonging to Group VIII in the Periodic Table and a compound thereof, such as a complex of rhodium and an olefin, chlorotris(triphenylphosphine) rhodium (Wilkinson catalyst) and rhodium (III) acetyl acetonate, which are conventional as a catalyst for the addition reaction. It is preferred that these complexes are dissolved in a solvent, such as alcohol compound, ether compounds or hydrocarbon compounds to be used.

The fluorocarbon siloxane rubber composition is not restricted and may be properly selected depending on the application, and may comprise various additives. Examples of the various additives include a dispersing agent, such as diphenylsilane diol, low polymer of dimethyl polysiloxane in which the terminal of the molecule chain is blocked with a hydroxyl group and hexamethyl disilazane; a heat resistance improver, such as ferrous oxide, ferric oxide, cerium oxide and octyl acid iron; and a colorant, such as a pigment.

The belt can be obtained by coating the surface of the support film having heat resistance with the fluorocarbon siloxane rubber composition and curing the resultant coated support film by the heating. Further optionally, the belt can be obtained by coating the support film with a coating liquid prepared by diluting the fluoro fluorocarbon siloxane rubber composition with a solvent, such as m-xylene hexafluoride and benzotrifluoride according to a general coating method, such as a spray coating, a dip coating and a knife coating. The heating-curing temperature and time may be properly selected from the ranges of from 100 to 500° C. (temperature) and from 5 seconds to 5 hours (time) depending on the type of the support film and the method for producing the belt.

The thickness of the mold-releasing layer disposed on the surface of the thermal resistant support film is not restricted and may be properly selected depending on the application. For obtaining an advantageous fixing properties of the image by preventing the peeling of the toner and the off-set of the toner component, the thickness is preferably from 1 to 200 μm, more preferably from 5 to 150 μm.

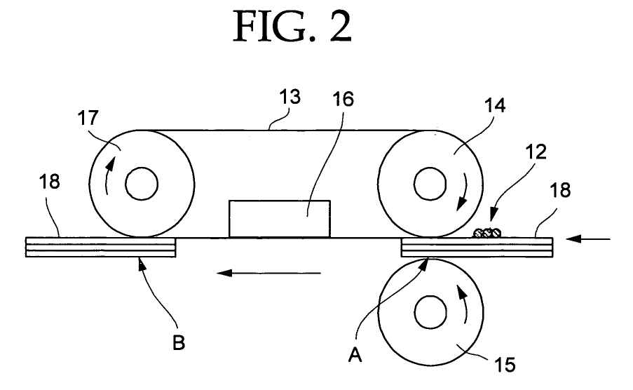

Here, with respect to an example of the fixing unit of the image by smoothing the image surface used in the method for forming the image according to the present invention, explanations are given in detail according to FIG. 2.

First, by an apparatus for forming the image (not illustrated in FIG. 2), the toner 12 is transferred to a label sheet for the electrophotography 18. The label sheet 18 to which the toner 12 is adhered is conveyed to the point A by a conveying unit (not illustrated in FIG. 2) and passes through between the heating roller 14 and the pressing roller 15 to be heated and pressed with the temperature (fixing temperature) and pressure which are enough high to soften satisfactorily the toner image-receiving layer of the label sheet 18 and the toner 12.

Here, the fixing temperature means a temperature of the surface of the toner image-receiving layer measured in a nip space between the heating roller 14 and the pressing roller 15 at the point A and is preferably from 80 to 190° C., more preferably from 100 to 170° C. The (fixing) pressure means a pressure of the surface of the toner image-receiving layer measured also in a nip space between the heating roller 14 and the pressing roller 15 at the point A and is preferably from 1 to 10 kgf/cm², more preferably from 2 to 7 kgf/cm².

The label sheet 18 thus heated and pressured is, next, conveyed by the fixing belt 13 to the cooling unit 16 and during the conveying of the label sheet 18, in the label sheet 18, a mold-releasing agent (not illustrated in FIG. 2) dispersed in the toner image-receiving layer is satisfactorily heated and molten. The molten mold-releasing agent is gathered to the surface of the toner image-receiving layer, so that in the surface of the toner image-receiving layer, a layer (film) of the mold-releasing agent is formed. The label sheet 18 conveyed to the cooling unit 16 is cooled by the cooling unit 16 to a temperature which is, for example, not higher than either the softening point of the binder resin used for the polymer of the toner image-receiving layer or the toner, or the temperature which is higher than the glass transition point of the above-noted binder resin by 10° C., wherein the temperature to which the label sheet 18 is cooled is preferably from 20 to 80° C., more preferably room temperature (25° C.). Thus, the layer (film) of the mold-releasing agent formed in the surface of the toner image-receiving layer is cooled and set, so that the mold-release agent layer is formed.

The cooled label sheet 18 is conveyed by the fixing belt 13 further to the point B and the fixing belt 13 moves along the tension roller 17. Accordingly, at the point B, the label sheet 18 is peeled from the fixing belt 13. It is preferred that the diameter of the tension roller 17 is so small designed that the label sheet 18 can be peeled from the fixing belt 13 by own stiffness (nerve) of the label sheet 18.

Hereinbelow, with respect to an example of the method for forming the image using the apparatus for forming the image equipped with the fixing unit of the image by smoothing the image surface, explanations are given specifically.

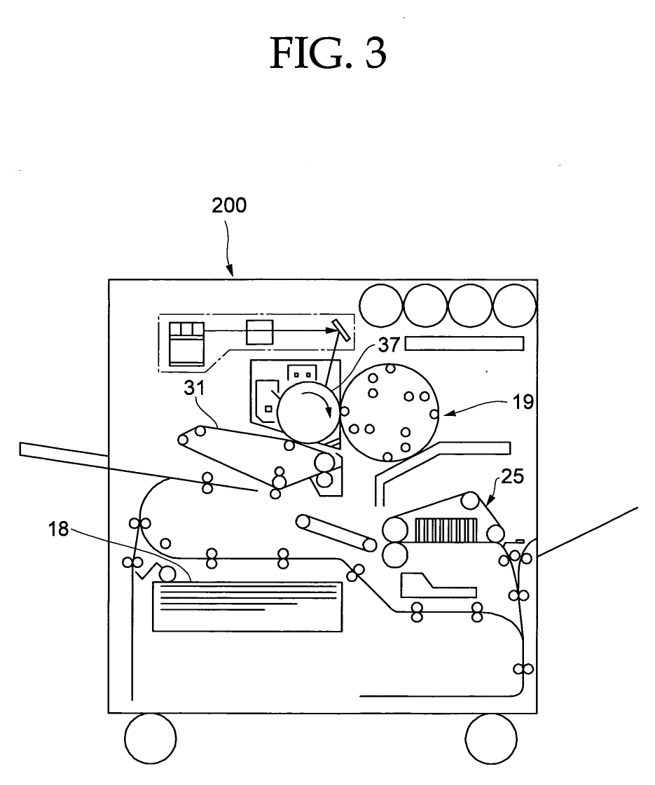

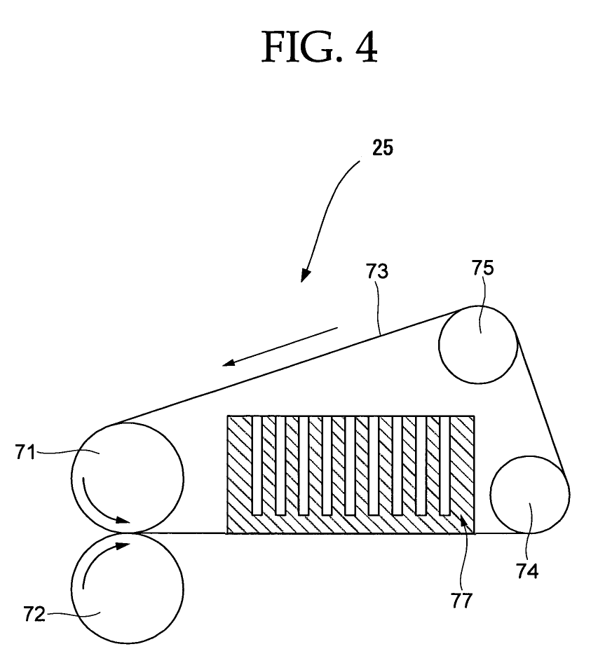

A fixing unit of the image by smoothing the image surface shown in FIG. 4 can be used in an apparatus for forming the image (e.g., a full-color laser printer DCC-500 (manufactured and sold by Fuji Xerox Co., Ltd.)) shown in FIG. 3 by converting the fixing unit of the image to a part of the belt fixing in the apparatus for forming the image.

As shown in FIG. 2, the apparatus for forming the image 200 includes photoconductive drum 37, development device 19, intermediate transfer belt 31, label sheet for the electrophotography 18, and fixing unit of the image by smoothing the image surface 25.

FIG. 4 shows the fixing unit of the image by smoothing the image surface which can be converted to the belt fixing part of the apparatus for forming the image 200 in FIG. 3.

As shown in FIG. 4, the fixing unit of the image by smoothing the image surface 25 comprises heat roller 71, peeling roller 74, tension roller 75, endless belt 73 supported rotatably by the tension roller 75 and pressure roller 72 contacted by pressure to the heat roller 71 through the endless belt 73.

Cooling heatsink 77 which forces the endless belt 73 to cool is arranged inside the endless belt 73 between the heat roller 71 and the peeling roller 74. The cooling heatsink 77 constitutes the cooling and sheet-conveying unit for cooling and conveying the label sheet for the electrophotography 18.

In the fixing unit of the image by smoothing the image surface 25 as shown in FIG. 3, the label sheet for the electrophotography 18 bearing a color toner image transferred and fixed on the surface of the label sheet, is so introduced into a press-contacting portion (or nip portion) between the heat roll 71 and the pressure roll 72 contacted by pressure to the heat roller 71 through the endless belt 73 that the color toner image in the label sheet faces to the heat roller 71, wherein while the label sheet 18 passes through the press-contacting portion between the heat roller 71 and the pressure roller 72, the color toner image is heated and fused to be fixed on the label sheet for the electrophotography 18.

Thereafter, the label sheet for the electrophotography 18 bearing the color toner image fixed in the image-receiving layer of the label sheet by heating the toner of the color toner image to a temperature of substantially from 120 to 130° C. at the press-contacting portion between the heat roller 71 and the pressure roller 72 is conveyed by the endless belt 73, while the toner image-receiving layer in the surface of the label sheet 18 is adhered to the surface of the endless belt 73. During the conveying of the label sheet 18, the endless belt 73 is forcedly cooled by the cooling heatsink 77 and the color toner image and the image-receiving layer are cooled and set, so that the label sheet for the electrophotography 18 is peeled from the endless belt 73 by the peeling roller 74 and own stiffness (nerve) of the label sheet 18.

The surface of the endless belt 73 after the peeling process is cleaned by removing a residual toner therefrom using a cleaner (not illustrated in FIG. 4) and prepared for the next fixing process.

<Label Sheet for Ink Jet Recording>

The label sheet for the ink jet recording comprises an image-recording layer comprising an image-receiving layer for the ink jet recording and a colorant, such as a water-soluble ink (e.g., a dye or a pigment), a liquid ink (, such as an oil-soluble ink) and a solid ink (which is a solid at normal temperature and is molten-liquidized for using).

<Label Sheet for Thermofusible Transfer>

The label sheet for the thermofusible transfer comprises, as an image-recording layer, a thermofusible ink-receiving layer, wherein examples of the thermofusible transfer include a transfer by the fusing in which the thermofusible ink in the thermofusible ink-receiving layer is heated by a thermosensitive head, fused and transferred onto the label sheet for the heat transfer.

<Label Sheet for Sublimation Dye Transfer>

The label sheet for the sublimation dye transfer comprises, as an image-recording layer, a thermodiffusive dye (subliminal dye) -receiving layer, wherein examples of the sublimation dye transfer include a transfer by the sublimation in which the thermodiffusive dye in the thermodiffusive dye-receiving layer is heated by a thermosensitive head, sublimated and transferred onto the label sheet for the heat transfer.

<Label Sheet for Thermosensitive Recording>

The label sheet for the thermosensitive recording comprises, as an image-recording layer, a heat-coloring layer and examples of the label sheet for the thermosensitive recording include a label sheet for the thermosensitive recording used in the thermo auto chrome method (TA method) in which the image is formed by repeating the heating using a thermosensitive head and the fixing.

Hereinbelow, the present invention is described in detail by referring to Examples which should not be construed as limiting for the scope of the present invention.

(Example 1)

—Production of Separator on Which Peeling Treating Layer is Disposed—

A surface of the raw paper made of a woodfree paper having a basis weight of 52 g/m² was coated with an aqueous solution of a polyvinyl alcohol and dried, thereby disposing a sealing layer. The sealing layer was coated with a 3% by mass toluene solution of a blended resin of 100 parts by mass of a silicone resin SRX-211 (manufactured and sold by Toray Silicone Co., Ltd.) and 0.6 part by mass of a silicone resin SRX-212 (manufactured and sold by Toray Silicone Co., Ltd.) using a wire coater so that the dried coating has a thickness of 1 μm and dried at 120° C. for 2 minutes, thereby producing the separator on which a peeling treating layer was disposed.

—Production of Base—

The both surfaces of the raw paper made of a woodfree paper having a basis weight of 52 g/m² were coated with an aqueous solution of a polyvinyl alcohol and dried to dispose a sealing layer, thereby producing the base.

—Disposing of Intermediate Layer—

By mixing 10 parts by mass of an acrylic latex (manufactured and sold by Seiko Chemicals Co., Ltd.; trade name: Hiros HE-1335; having a glass transition temperature (Tg) of 15° C. and a breaking extension of 20.4%) and 16 parts by mass of water, a coating liquid for the intermediate layer was obtained. With the obtained coating liquid for the intermediate layer, a surface of the base on which a toner image-receiving layer will be disposed, was coated using a bar coater so that the dried coating has a thickness of 2 μm and dried, thereby disposing the intermediate layer on the base.

—Disposing of Toner Image-Receiving Layer—

By mixing 100 parts by mass of a water-dispersible polyester resin (manufactured and sold by Unitika Ltd.; trade name: Elitel KZA, test sample 1; having a glass transition temperature (Tg) of 65° C. and a breaking extension of 0.2%), 5 parts by mass of a carnauba wax as a releasing agent (manufactured and sold by Chukyo Yushi Co., Ltd.; trade name: Cellosol 524), 7.5 parts by mass of a water dispersion of a white pigment (which is prepared by dispersing TiO₂ (manufactured and sold by Ishihara Sangyo Kaisha, Ltd.; trade name: TIPAQUE R780-2) and a polymer dispersant in water), 8 parts by mass of a surfactant (manufactured and sold by NOF CORPORATION; trade name: Rapisol D-337; having a solid content of 10% by mass) and 7 parts by mass of an antistatic agent (manufactured and sold by NOF CORPORATION; trade name: Rapisol B-90; having a molecular weight of 445.58), a coating liquid for the toner image-receiving layer was obtained.

With the obtained coating liquid for the toner image-receiving layer, the intermediate layer was coated using a wire coater so that the dried coating has a thickness of 7 μm and dried at 100° C. for 5 minutes, thereby disposing the toner image-receiving layer on the intermediate layer.

—Disposing of Adhesive Layer—

By mixing 10 parts by mass of a NBR latex (manufactured and sold by Zeon Corporation; trade name: Nipol SX-1503; having a glass transition temperature (Tg) of −20° C. and a breaking extension of 241.1%), 1.6 parts by mass of an polyethylene oxide (manufactured and sold by MEISEI CHEMICAL WORKS, LTD.; trade name: ALKOX R 1000) and 34.4 parts by mass of water, a coating liquid for the adhesive layer was obtained.

With the obtained coating liquid for the adhesive layer, a surface of the base on which the toner image-receiving layer will not be disposed was coated using a wire coater so that the dried coating has a thickness of 20 μm and dried at 120° C. for 2 minutes, thereby disposing the adhesive layer on the base.

The glass transition temperature of the thermoplastic resin in the adhesive layer (a resin mixture of a NBR and a polyethylene oxide) was −32° C.

The obtained adhesive layer in the above-produced laminated form comprising the base, the intermediate layer disposed on the base, the toner image-receiving layer disposed on the intermediate layer and the adhesive layer disposed on a surface of the base on which no other layer is disposed, was adhesive-bonded to the peeling treating layer in the above-produced separator on which the peeling treating layer was disposed, thereby producing the label sheet of Example 1.

(Example 2)

In substantially the same manner as in Example 1, except that the method for disposing the intermediate layer in Example 1 was changed to a method described as follows, the label sheet of Example 2 was produced.

—Disposing of Intermediate Layer—

By mixing 5.7 parts by mass of an acryl vanish (manufactured and sold by Seiko Chemicals Co., Ltd.; trade name: Hiros BH-997L; having a glass transition temperature (Tg) of 10° C. and a breaking extension of 25.8%), 1.6 parts by mass of an polyethylene oxide (manufactured and sold by MEISEI CHEMICAL WORKS, LTD.; trade name: ALKOX R 1000) and 34.7 parts by mass of water, a coating liquid for the intermediate layer was obtained. With the obtained coating liquid for the intermediate layer, a surface of the base on which the toner image-receiving layer will be disposed was coated using a bar coater so that the dried coating has a thickness of 7 μm and dried, thereby disposing the intermediate layer on the base.

The glass transition temperature of the thermoplastic resin in the intermediate layer (a resin mixture of an acryl vanish and a polyethylene oxide) was 10° C.

(Example 3)

In substantially the same manner as in Example 1, except that the method for disposing the intermediate layer in Example 1 was changed to a method described as follows, the label sheet of Example 3 was produced.

—Disposing of Intermediate Layer—

By mixing 10 parts by mass of an acryl latex (manufactured and sold by Seiko Chemicals Co., Ltd.; trade name: Hiros HE-1066; having a glass transition temperature (Tg) of 0° C. and a breaking extension of 83.6%) and 16 parts by mass of water, a coating liquid for the intermediate layer was obtained. With the obtained coating liquid for the intermediate layer, a surface of the base on which the toner image-receiving layer will be disposed was coated using a bar coater so that the dried coating has a thickness of 7 μm and dried, thereby disposing the intermediate layer on the base.

(Example 4)

In substantially the same manner as in Example 1, except that the method for disposing the intermediate layer in Example 1 was changed to a method described as follows, the label sheet of Example 4 was produced.

—Disposing of Intermediate Layer—

By mixing 10 parts by mass of a NBR latex (manufactured and sold by Zeon Corporation; trade name: Nipol SX-1503; having a glass transition temperature (Tg) of −20° C. and a breaking extension of 241.1%) and 16 parts by mass of water, a coating liquid for the intermediate layer was obtained. With the obtained coating liquid for the intermediate layer, a surface of the base on which the toner image-receiving layer will be disposed was coated using a bar coater so that the dried coating has a thickness of 7 μm and dried, thereby disposing the intermediate layer on the base.

(Example 5)

In substantially the same manner as in Example 1, except that the method for disposing the intermediate layer in Example 1 was changed to a method described as follows, the label sheet of Example 5 was produced.

—Disposing of Intermediate Layer—

By mixing 10 parts by mass of an acryl latex (manufactured and sold by Seiko Chemicals Co., Ltd.; trade name: Hiros HE-1335; having a glass transition temperature (Tg) of 15° C. and a breaking extension of 20.4%), 1.6 parts by mass of an polyethylene oxide (manufactured and sold by MEISEI CHEMICAL WORKS, LTD.; trade name: ALKOX R 1000) and 34 parts by mass of water, a coating liquid for the intermediate layer was obtained. With the obtained coating liquid for the intermediate layer, a surface of the base on which the toner image-receiving layer will be disposed was coated using a bar coater so that the dried coating has a thickness of 10 μm and dried, thereby disposing the intermediate layer on the base.

The glass transition temperature of the thermoplastic resin in the intermediate layer (a resin mixture of an acryl latex and a polyethylene oxide) was −25° C.

(Comparative Example 1)

In substantially the same manner as in Example 1, except that the method for disposing the intermediate layer in Example 1 was changed to a method described as follows, the label sheet of Comparative Example 1 was produced.

—Disposing of Intermediate Layer—

By mixing 5.7 parts by mass of an acryl vanish (manufactured and sold by Seiko Chemicals Co., Ltd.; trade name: Hiros BH-997L; having a glass transition temperature (Tg) of 65° C. and a breaking extension of 0.2%) and 16.3 parts by mass of water, a coating liquid for the intermediate layer was obtained. With the obtained coating liquid for the intermediate layer, a surface of the base on which the toner image-receiving layer will be disposed was coated using a bar coater so that the dried coating has a thickness of 7 μm and dried, thereby disposing the intermediate layer on the base.

(Comparative Example 2)

In substantially the same manner as in Example 1, except that the method for disposing the intermediate layer in Example 1 was changed to a method described as follows, the label sheet of Comparative Example 2 was produced.

—Disposing of Intermediate Layer—

By mixing 10 parts by mass of a NBR latex (manufactured and sold by Zeon Corporation; trade name: Nipol SX-1503; having a glass transition temperature (Tg) of −20° C. and a breaking extension of 241.1%), 1.6 parts by mass of an polyethylene oxide (manufactured and sold by MEISEI CHEMICAL WORKS, LTD.; trade name: ALKOX R 1000) and 34.4 parts by mass of water, a coating liquid for the intermediate layer was obtained. With the obtained coating liquid for the intermediate layer, a surface of the base on which the toner image-receiving layer will be disposed was coated using a bar coater so that the dried coating has a thickness of 15 μm and dried, thereby disposing the intermediate layer on the base.

The glass transition temperature of the thermoplastic resin in the intermediate layer (a resin mixture of a NBR latex and a polyethylene oxide) was −32° C.

(Comparative Example 3)

In substantially the same manner as in Example 1, except that the method for disposing the intermediate layer in Example 1 was changed to a method described as follows, the label sheet of Comparative Example 3 was produced.

—Disposing of Intermediate Layer—

By mixing 10 parts by mass of a water-dispersible polyester resin (manufactured and sold by UNITIKA Co., Ltd.; trade name: Elitel KZA, test sample 1; having a glass transition temperature (Tg) of 65° C. and a breaking extension of 0.2%) and 10 parts by mass of water, a coating liquid for the intermediate layer was obtained. With the obtained coating liquid for the intermediate layer, a surface of the base on which the toner image-receiving layer will be disposed was coated using a bar coater so that the dried coating has a thickness of 7 μm and dried, thereby disposing the intermediate layer on the base.

<Method for Measuring Breaking Extension of Intermediate Layer>

In Example 1 to 5 and Comparative Example 1 to 3, each composition for the intermediate layer was coated on the hydrophobic base, such as a polyethylene so that the resultant coating has a thickness of from 10 to 40 μm and the resultant coating was dried, thereby obtaining the intermediate layer. Out of the obtained intermediate layer, the sample for measuring the breaking extension of the intermediate layer in the form of a strip having a size of 5×70 mm was cut. With respect to the sample, the breaking extension was measured using a tensile tester (manufactured and sold by Orientech Co., Ltd.: trade name; Tensilon RTM-50) under the condition where the tensile strength is 500 mm/min. The breaking extension was measured in terms of elongation (%) which is the ratio of an extension length of the breaking point in the sample to the original length of the sample. The result of the measurement is shown in Table 2.

<Forming Image>

Using a full color laser printer (manufactured and sold by Fuji Xerox Co., Ltd.; trade name: DCC-500) shown in FIG. 3 as an apparatus for forming the image in which the original fixing part was converted to the fixing unit of the image by smoothing the image surface shown in FIG. 4, the image was formed and the treatment of fixing by smoothing of the image was performed under the following conditions.

—Toner—

Toner binder resin: a color toner resin for a color laser printer (manufactured and sold by Fuji Xerox Co., Ltd.; trade name: DC-1250PF) having a glass transition temperature (Tg) of 65° C. and a breaking extension of less than 0.1% (unmeasurable).

—Belt—

Support in the composition of the belt: a polyimide (PI) film having a width of 50 cm and a thickness of 80 μm.

Mold-releasing layer of the belt: The mold-releasing layer of the belt was disposed on the above-noted support as a film (having a thickness of 50 μm) of a fluorocarbonsiloxane rubber produced by vulcanization-curing a fluoroelastomer (manufacture and sold by Shin-Etsu Chemical Co., Ltd.; trade name: SIFEL 610) which is a precursor of a fluorocarbonsiloxane rubber.

—Process for Heating and Pressing—

Temperature of the heating roller: 140° C.

Nip pressure: 130 N/cm²

—Process for Cooling—

Cooling unit: the length of the heat sink is 80 mm

Conveying speed: 53 mm/second

<Evaluation of Adhesion Resistance>

The label sheets were preserved under 40° C., 80%RH for 24 hours and a sample for evaluation of adhesion resistance was prepared in such a manner that two label sheets are superimposed by contacting the toner image-receiving layer of a label sheet with that of another label sheet, thereby obtaining the sample comprising two label sheets. The obtained sample having a size of 3.5 cm×3.5 cm was subject to the pressing by a load of 500 g and left under the pressing for 7 days. With respect to the resultant sample, the adhesion resistance of the label sheet was evaluated by observation of peeling a label sheet from another label sheet in the sample according to the following criteria. The result of the evaluation is shown in Table 2. According to the present invention, the adhesion resistances represented by the following criteria 1 and 2 are practically qualified.

[Evaluation Criteria]

1 there was no peeling sound and no adhesion trace.
2 there was a light peeling sound or a light adhesion trace.
3 there was an adhesion trace in less than 25% of all evaluated samples.
4 there was an adhesion trace in from 25to 50 % of all evaluated samples.
5 there was an adhesion trace in 50% or more of all evaluated samples.
   <Evaluation of Crazing>

Using the apparatus for forming the image, an image having a size of 10 cm×10 cm in maximum density of black was formed in a sample of the label sheet and the sample was left under a condition of 10° C., 15% RH for 1 day. Bars having respectively the diameter of 1, 2, 3, 4 and 5 cm were prepared. The adhesive layers of the samples from which the separators were peeled off, were contacted with the surface of the above-prepared bars and adhesive-bonded to the surface of the bars. With respect to the samples of the label sheet adhesive-bonded to the surface of the bars, it is observed whether the crazing was caused or not in the samples and the minimum diameter of the bar to which a sample having no crazing is adhesive-bonded, was noted. The result of the evaluation is shown in Table 2. According to the present invention, “the minimum diameter is 3 cm or less” is practically qualified.

<Evaluation of Glossiness>

Using the apparatus for forming the image, an image having a size of 10 cm×10 cm in 6 densities of black, such as 0, 20,40, 60, 80 and 100% was formed in the sample of the label sheet. The glossinesses of the images in 6 densities were respectively measured according to JIS Z 8741 using a digital variable gloss meter (manufactured and sold by Suga Test Instrument Co., Ltd.; trade name: UGV-5D) under the condition where the acceptance angle is 20° and the minimum value of the glossiness was noted. The result of the measurement is shown in Table 2. According to the present invention, the glossiness is preferably 75 or more.

<Evaluation of Crazing During Cutting of Label Sheet>

With respect to the sample of the label sheet, the crazing was evaluated by observation of the crazing caused in the toner image-receiving layer, when the sample was cut along a guide line for cutting prepared by perforation, according to the following criteria.

[Evaluation Criteria]

A there was no crazing in the toner image-receiving layer.

B there was slightly crazing in the toner image-receiving layer.

C there was obviously crazing in the toner image-receiving layer.

TABLE 2

| | | | | | | | Crazing |
|---|---|---|---|---|---|---|---|
| | Intermediate Layer | | | | | | during |
| | Breaking | | | Flex | | | cutting of |
| | Extension | G.T.T.⁽¹⁾ | Thickness | Crazing⁽²⁾ | Adhesion | | label |
| | (%) | (° C.) | (μm) | (cm) | Resistance | Glossiness | sheet |
| Ex. 1 | 20.4 | 15 | 2 | 3 | 1 | 77 | B |
| Ex. 2 | 25.8 | 10 | 7 | 3 | 2 | 83 | B |
| Ex. 3 | 83.6 | 0 | 7 | 3 | 1 | 80 | B |
| Ex. 4 | 241.1 | −20 | 7 | 2 | 2 | 86 | A |
| Ex. 5 | 330.1 | −25 | 10 | 1 | 2 | 90 | A |
| Compara. | 0.2 | 65 | 7 | 5 | 1 | 74 | C |
| Ex. 1 | | | | | | | |
| Compara. | 426.5 | −32 | 15 | 1 | 4 | 92 | A |
| Ex. 2 | | | | | | | |
| Compara. | 0.25 | 65 | 7 | 5 | 1 | 80 | C |
| Ex. 3 | | | | | | | |

wherein “G.T.T.⁽¹⁾” means Glass Transition Temperature and
“Flex Crazing⁽²⁾” means the crazing caused in the image-recording layer when the recording label is adhesive-bonded to a curved surface of a medium in which the image is transferred.

From the result shown in Table 2, it is confirmed that the image-recording label sheets produced in Examples 1 to 5, in which the glass transition temperature (Tg 1) of the thermoplastic resin in the toner image-receiving layer, the glass transition temperature (Tg 2) of the thermoplastic resin in the intermediate layer and the glass transition temperature (Tg 3) of the thermoplastic resin in the adhesive layer satisfy the inequality: Tg 1>Tg 2>Tg 3, are more excellent than the image-recording label sheets produced in Comparative Examples 1 to 3, in which the above-noted glass transition temperatures (Tgs 1 to 3) do not satisfy the inequality: Tg 1>Tg 2>Tg 3, in that the flex crazing and the crazing caused during the cutting of the label sheet, can be prevented and the label sheet is excellent in adhesive resistance.

On the other hand, with respect to the label sheets produced in Comparative Examples 1 and 3, in which (Tg 1=Tg 2)>Tg 3, the flex crazing and the crazing during the cutting of the label sheet was caused and it is confirmed that with respect to the label sheet produced in Comparative Examples 2, in which Tg 1>(Tg 2=Tg 3), the adhesion resistance is poor.

The image-recording label sheet according to the present invention is excellent in that the flex crazing in the image-recording layer of the label sheet, which is caused when the image-recording label is adhesive-bonded to the curved or uneven surface of the medium in which the image is transferred and the crazing caused when the label sheet is cut can be prevented and the adhesion resistance of the label sheet is so excellent that the label sheet can be widely applied to the label sheet for the electrophotography, the label sheet for the thermofusible transfer, the label sheet for the sublimation, dye transfer, the label sheet for the thermosensitive recording and the label sheet for the ink jet recording.

1. An image-recording label sheet comprising:
a separator,
an adhesive layer,
a base,
an intermediate layer,
and an image-recording layer in this order,
wherein every one of the image-recording layer, the intermediate layer and the adhesive layer comprises a thermoplastic resin and the glass transition temperature (Tg 1) of the thermoplastic resin in the image-recording layer, the glass transition temperature (Tg 2) of the thermoplastic resin in the intermediate layer and the glass transition temperature (Tg 3) of the thermoplastic resin in the adhesive layer satisfy the inequality: Tg 1>Tg 2>Tg 3.

2. The image-recording label sheet according to claim 1,
wherein the glass transition temperature (Tg 1) of the thermoplastic resin in the image-recording layer is from 40° C. to 100° C., the glass transition temperature (Tg 2) of the thermoplastic resin in the intermediate layer is from −50° C. to 50° C. and the glass transition temperature (Tg 3) of the thermoplastic resin in the adhesive layer is 0° C. or lower.

3. The image-recording label sheet according to claim 1, wherein the breaking extension (S1) of the thermoplastic resin in the image-recording layer, the breaking extension (S2) of the thermoplastic resin in the intermediate layer and the breaking extension (S3) of the thermoplastic resin in the adhesive layer satisfy the inequality: S1<S2<S3.

4. The image-recording label sheet according to claim 3,
wherein the breaking extension (S2) of the thermoplastic resin in the intermediate layer is 20% or more and is less than the breaking extension (S3) of the thermoplastic resin in the adhesive layer.

5. The image-recording label sheet according to claim 1,
wherein the thermoplastic resin in the intermediate layer is at least one of a water-soluble resin and a water-dispersible resin.

6. The image-recording label sheet according to claim 5,
wherein the thermoplastic resin in the intermediate layer is at least one of a water-dispersible polyester resin and a water-dispersible acrylic resin.

7. The image-recording label sheet according to claim 1,
wherein the thickness of the intermediate layer is from 1 μm to 10 μm and is less than that of the image-recording layer.

8. The image-recording label sheet according to claim 1,
wherein the image-recording layer is a layer which comprises an image-receiving layer and a colorant.

9. The image-recording label sheet according to claim 8,
wherein the thermoplastic resin in the image-receiving layer is at least one of a water-soluble resin and a water-dispersible resin.

10. The image-recording label sheet according to claim 9,
wherein the thermoplastic resin in the image-receiving layer is at least one of a water-dispersible polyester resin and a water-dispersible acrylic resin.

11. The image-recording label sheet according to claim 8,
wherein the image-receiving layer is at least one selected from the group consisting of a toner image-receiving layer, an image-receiving layer for a thermofusible transfer, an image-receiving layer for a sublimation dye transfer, an image-receiving layer for a thermosensitive recording and an image-receiving layer for an ink jet recording.

12. The image-recording label sheet according to claim 1,
wherein a peeling treating layer is disposed between the separator and the adhesive layer.

13. The image-recording label sheet according to claim 1,
wherein a perforation as a guide line for the cutting is prepared.

14. The image-recording label sheet according to claim 13,
wherein the perforation is prepared after the image-recording.

15. The image-recording label sheet for the electrophotography according to claim 11,
wherein the image-recording label sheet which comprises:
a separator,
an adhesive layer,
a base,
an intermediate layer,
and a toner image-receiving layer in this order.

16. The image-recording label sheet for the electrophotography according to claim 15,
wherein the toner image-receiving layer comprises a wax having a melting point of from 70° C. to 100° C. and the amount of the wax in the toner image-receiving layer is from 1% to 20% by mass, based on the mass of the toner image-receiving layer.

17. A method for forming the image comprising:
forming the toner image, and
fixing the image by smoothing the image surface,
wherein the toner image is formed in the surface of the toner image-receiving layer of the image-recording label sheet for the electrophotography which comprises:
a separator,
an adhesive layer,
a base,
an intermediate layer,
and a toner image-receiving layer in this order,
and the surface of the toner image formed according to the process for forming the toner image is smoothed.

18. The method for forming the image according to claim 17,
wherein the process for fixing the image by smoothing the image surface is a process in which the toner image is heated, pressed and cooled and the label sheet is peeled from the belt using a fixing unit of the image by smoothing the image surface equipped with a heating-pressing unit, a belt and a cooling unit.
